(19) United States
(12) Patent Application Publication
(10) Pub. No.: US 2026/0360341 A1
(43) Pub. Date: Nov. 12, 2026

(54) ENHANCED VIRTUAL INSTRUMENT TECHNIQUES

(71) Applicant: Apple Inc., Cupertino, CA (US)

(72) Inventors: Patchen L. Preston, Los Gatos, CA (US); Ari Brown, San Francisco, CA (US); Andrew R. Barrett, San Jose, CA (US)

(73) Assignee: Apple Inc., Cupertino, CA (US)

(21) Appl. No.: 19/672,432

(22) Filed: May 8, 2026

Related U.S. Application Data
(60) Provisional application No. 63/803,508, filed on May 9, 2025.

(51) Int. Cl. G10H 1/02

(52) U.S. Cl. CPC G10H 1/02

(57) ABSTRACT

Embodiments of the present disclosure can provide systems, methods, and computer-readable medium for selecting a playing mode for playing a note that is associated with a virtual instrument (VI) is disclosed. First Musical Instrument Digital Interface (MIDI) data corresponding to a first note that is associated with the VI and second MIDI data corresponding to a second note that is associated with the VI may be obtained. A playing mode may be selected based on a velocity of the second note, as well a pitch interval and time between the first and second note. The playing mode may be selected from 1) a first playing mode during which the second note sounds while the first note is sounding or 2) a second playing mode during which the first note is interrupted with the second note. The second note may be played according to the selected playing mode.

### CROSS-REFERENCES TO RELATED APPLICATIONS

This application claims the benefit of U.S. Provisional Application No. 63/803,508, filed on May 9, 2025, which is incorporated by reference in its entirety for all purposes.

### BACKGROUND

Within a Digital Audio Workstation (DAW), virtual musical instruments, such as musical instrument digital interface (MIDI)-based or software-based keyboards, string instruments, and the like, may be used to create music from recordings of real instruments. While these instruments are enjoyable to amateur and experienced users, a lack of organic performance nuances, the limited supply of audio samples, the inability to accurately replicate complex, physical articulations, and the difficulty simulating playing noise (e.g., instrument handling sounds, string noise, etc.) can cause the resulting playback to lack realism. Additionally, programming in DAW often results in perfectly timed, rigid notes, causing the music produced by the instrument to sound sterile, repetitive, and lacking in the slight, natural variations of a live performance. Real music involves timing, velocity, and articulation variations. Simulating the features conventionally requires meticulous, time-consuming manual editing. For example, to improve realism, users often rely on modulation (using MIDI controllers), adjusting velocity for variation, and using advanced sample libraries with multiple articulations. Conventional techniques are complex, tedious, and require experienced users. The disclosed techniques address these issues, individually, and collectively.

### SUMMARY

Embodiments of the present disclosure can provide systems, methods, and computer-readable medium for implementing enhanced virtual instrument techniques.

In some embodiments, a computer-implemented method for enhancing playback realism of a virtual instrument while reducing a memory footprint associated with the virtual instrument is disclosed. The method may comprise obtaining a first set of fundamental layer audio samples comprising respective fundamental layer recordings of individual musical notes played by a physical instrument. The method may comprise obtaining a second set of harmonic layer audio samples comprising respective harmonic layer recordings of the individual musical notes played by the physical instrument. The method may comprise executing operations that phase align the first set of fundamental layer audio samples and the second set of harmonic layer audio samples. The method may comprise processing the set of harmonic layer audio samples with one or more frequency-selective filters. The method may comprise receiving input data indicating selection of a particular musical note of a plurality of musical notes. The method may comprise presenting, via a speaker of an electronic device, first audio comprising a combination of a first audio sample of the set of fundamental layer audio samples and a second audio sample of the set of harmonic layer audio samples.

In some embodiments, the one or more frequency-selective filters comprise a hipass filter or a notch filter.

In some embodiments, executing the operations that phase align the first set of fundamental layer audio samples and the second set of harmonic layer audio samples further comprises removing a pitch offset and excess pitch variations of the first set of fundamental layer audio samples and the second set of harmonic layer audio samples.

In some embodiments, the method may further comprise 1) randomly selecting the first audio sample from the set of fundamental layer audio samples and 2) randomly selecting the second audio sample from the set of harmonic layer audio samples.

In some embodiments, the method may further comprise adjusting an offset volume of the second audio sample.

In some embodiments, the method may further comprise varying an amplitude envelope of the second audio sample.

In some embodiments, the method may further comprise modifying an amplitude component, a tonal component, or a temporal component of the first audio sample of the set of fundamental layer audio samples.

In some embodiments, an additional computer-implemented method for selecting a playing mode for playing a note that is associated with a virtual instrument corresponding to a physical instrument is disclosed. This method (“the method”) may comprise obtaining, by a computing device, first Musical Instrument Digital Interface (MIDI) data corresponding to a first note that is associated with the virtual instrument and second MIDI data corresponding to a second note that is associated with the virtual instrument. The method may comprise identifying, by the computing device and based at least in part on the first MIDI data and the second MIDI data, a velocity of the second note, a pitch interval between the first note and the second note, and a difference between a first time corresponding to the first note and a second time corresponding to the second note. The method may comprise selecting, by the computing device and based at least in part on the velocity, the pitch interval, and the difference between the first time and the second time, the playing mode for playing the second note. In some embodiments, the playing mode may be selected from 1) a first playing mode that, when utilized, causes the second note to sound while the first note is sounding or 2) a second playing mode that, when utilized, causes the first note to be interrupted with the second note. The method may comprise executing, by the computing device, operations that play the second note according to the playing mode.

In some embodiments, the method may further comprise determining, by the computing device, a duration that the first note has been played, wherein the playing mode for playing the second note is selected further based at least in part on the duration that the first note has been played.

In some embodiments, the second playing mode for playing the second note is selected based at least in part on 1) determining, from the second MIDI data, that the velocity of the second note falls below a predefined velocity threshold value, 2) determining, based at least in part on the first MIDI data and the second MIDI data, that the pitch interval between the first note and the second note falls below a predefined interval threshold, 3) determining, based at least in part on the first MIDI data and the second MIDI data, that the difference between the first time corresponding to the first note and the second time corresponding to the second note exceeds a predefined timing threshold, and 4) determining, that the difference between the first time and the second time is less than a portion of the duration of the first note.

In some embodiments, the predefined velocity threshold value is seventy, and the predefined interval threshold corresponds to seven half steps.

In some embodiments, the second playing mode for playing the second note is selected based at least in part on 1) determining, from the second MIDI data, that the velocity of the second note meets or exceeds a predefined velocity threshold value, 2) determining, based at least in part on the first MIDI data and the second MIDI data, that the pitch interval between the first note and the second note exceeds a predefined interval threshold, and 3) determining, based at least in part on the first MIDI data and the second MIDI data, that the difference between the first time corresponding to the first note and the second time corresponding to the second note exceeds a predefined timing threshold.

In some embodiments, the predefined interval threshold corresponds to two half steps.

In some embodiments, the first playing mode is a default playing mode, and selecting the second playing mode causes the default playing mode to be overridden.

Systems, devices, and computer readable media are disclosed, each of which may comprise one or more memories on which computer-readable instructions corresponding to the methods disclosed herein may be stored. The computer-readable instructions may be executed by one or more processors of the disclosed systems and/or computing devices to execute the methods disclosed herein. One or more computer programs can be configured to perform operations corresponding to the described methods by virtue of including instructions that, when executed one or more processors, cause the one or more processors to perform the operations.

The following detailed description together with the accompanying drawings will provide a better understanding of the nature and advantages of the present disclosure.

### BRIEF DESCRIPTION OF THE DRAWINGS

FIG. 1 is a simplified block diagram illustrating an example architecture for implementing the virtual instrument techniques described herein, according to at least one embodiment.

FIG. 2 is a simplified block diagram illustrating an example user interface for a virtual instrument (e.g., an American Upright Bass) that may be provided utilizing a computing device, according to at least one embodiment.

FIG. 3 is a simplified flow diagram illustrating an example method for enhancing realism of virtual instrument playback as described herein, according to at least one example.

FIGS. 4A-4F depicts a number of graphs that illustrate example fundamental and harmonic layers, according to at least one embodiment.

FIG. 5 is an illustration of example modifications to be made to audio output to provide enhanced fixed length slide realism (also referred to as a “Portamento slide”), according to at least one embodiment.

FIG. 6 depicts a graph and corresponding table illustrating pitch changes of a slide based on time estimating a real player's motion, according to at least one embodiment.

FIG. 7 depicts a graph and tables illustrating dB offset values depending on the slide length of a fixed length slide (e.g., a Portamento slide), according to at least one embodiment.

FIG. 8 is a simplified flow diagram illustrating another example method for enhancing realism of virtual instrument playback as described herein based on blending monophonic and polyphonic behavior, according to at least one embodiment.

FIG. 9 is an illustration of a process for gaining information regarding inflection points, according to at least one embodiment.

FIG. 10 is a graph representing a number of inflection points, according to at least one embodiment.

FIG. 11 is a graph corresponding to a piecewise function and depicting values of an noteOn delta term, according to at least one embodiment.

FIG. 12 is an illustration that visually depicts the parameters for calculating an energy rating, according to at least one embodiment.

FIG. 13 provides an example list that depicts an example priority order of articulations, according to at least one embodiment.

FIG. 14 is a graph corresponding to a piecewise function for identifying a decibel (dB) offset based on an energy rating, according to at least one embodiment.

FIG. 15 is an illustration that visually depicts aspects of handling noise timing, according to at least one embodiment.

FIG. 16 is an illustration that visually depicts aspects of hand position change timing, according to at least one embodiment.

FIG. 17 is an illustration that visually depicts aspects of combining sound layers to create a pickup note, according to at least one embodiment.

FIG. 18 is a graph and corresponding piecewise function for identifying the timing of handling noise provided before a main note, according to at least one embodiment.

FIG. 19 is a simplified block diagram illustrating an example of a musical performance system that can enable a user to compose and create music with a number of virtual instruments on a music application as described herein, according to at least one example.

### DETAILED DESCRIPTION

Certain embodiments of the present disclosure relate to devices, computer-readable medium, user interfaces, and methods for implementing enhanced virtual instrument techniques. Examples are described with reference to virtual instruments, and user interfaces of the virtual instruments for playing notes and/or music (e.g., electronic audio files) with the virtual instruments. Virtual instruments can be designed to mimic nearly any musical instrument, with examples including, but not limited to, string instruments (e.g., an upright bass), brass/horns, woodwinds, various keyboards, and the like. Although examples herein may utilize particular stringed instruments, the same examples may be similarly applied to other types of musical instruments. Thus, any reference to a “string” may similarly be applied to a “key” of another type of instrument. A computing device (e.g., a mobile phone, tablet, or other portable, handheld device, or a desktop computer, laptop, etc.) may be configured to present various user interfaces and corresponding user interface elements that enable the implementation of the disclosed enhanced virtual instrument techniques.

The disclosed enhancements may include any suitable combination of 1) a Harmonic Sample Recombination (HSR) method, 2) techniques for improving fixed-length slide realism, 3) techniques for blending monophonic and polyphonic behavior, 4) a method for predicting motion for continuous MIDI controller data with which additional sounds may be triggered, 5) an improved method for calculating an energy rating with which attack smoothing and handling noise may be influenced, 6) a scheme for determining a prioritization of simultaneous events with different articulations, and 7) a method for retroactively editing events within a latency window based on context. Each of these methods and techniques provided above is discussed in further detail below with respect to corresponding sections of this disclosure and is not repeated here, for brevity.

By utilizing the techniques described here, the computing device may more realistically simulate various stylistic features or playing techniques of the instrument.

### DEFINITIONS

A “MIDI controller” refers to a device (e.g., a hardware device with keys, knobs, faders, etc.) that sends Musical Instrument Digital Interface (MIDI) data to control other electronic musical instruments, software, or sound modules, typically to play or produce music. A MIDI controller need not produce sound on its own. Instead, it may act as an input device for virtual instruments, such as those provided via a Digital Audio Workstation (DAW).

A “Digital Audio Workstation (DAW)” is intended to refer to software used for recording, editing, mixing, and producing audio files on a computer or mobile device. A DAW may execute as a comprehensive, all-in-one virtual studio, allowing users to record, edit, mix, and create music using virtual instruments, pre-recorded loops, and voice recordings. Example DAWs include, but are not limited to Logic Pro®, GarageBand®, or the like. A DAW may organize music into tracks (e.g., audio, virtual instruments, or MIDI), allowing for in-depth processing via virtual instruments and effects plugins.

A “virtual instrument” refers to a software-based plugin or module used in music production to imitate the sounds of real instruments (pianos, drums, orchestras) or create new sounds via synthesis. A virtual instrument may be provided a DAW, or hosted by a DAW, and may allow users to produce music without physical instruments or a recording studio.

An “envelope” refers to a function that controls' a sound's amplitude over time. An envelope describes how a sound's volume (amplitude) changes over time, shaping its character from initiation to silence. It may include four stages (e.g., attack, decay, sustain, and release), which determine how a sound starts, peaks, holds, and fades.

“Fundamental” refers to the lowest frequency of sound which determines the pitch of a note.

“Harmonic” refers to a frequency that is an integer multiple of the fundamental frequency.

A “MIDI note” refers to a digital representation of a musical pitch and its associated performance data. A MIDI note is not the actual sound itself, but rather the information about a note's pitch, duration, velocity, and the like that is sent to a MIDI-enabled device.

“Phase” refers to where a periodic audio waveform is in its cycle at a given time.

“Phase alignment” refers to a process of ensuring two or more audio waveforms have the same pitch and phase so that they reinforce each other positively when combined.

“Reference oscillator” refers to an electronic device that generates a stable and precise frequency signal, serving as a timing reference. Common reference oscillators may be used in phase alignment to provide a stable, shared timing foundation for multiple, independent signal generators or components. They may act as a common reference for Phase-Locked Loops, ensuring that multiple systems align their phase and frequency, minimizing drift and phase skew across channels.

A “sample” refers to a short digital audio recording including a single sound produced by a musical instrument.

A “hipass filter” is intended to refer to an audio tool that attenuates frequencies below a set threshold while allowing higher frequencies to pass through.

A “notch filter” (sometimes referred to as a “band-stop filter” or “band-reject filter”) is intended to refer to a specialized equalizer (EQ) tool that may act as a narrow-band rejection filter, designed to remove specific, unwanted frequencies (e.g., high-pitched ringing, hums, or resonances), without affecting the surrounding audio.

An “articulation” refers to the direction or style in which a single note, series of notes, or other non-pitched sounds is played, influencing their duration, intensity, and connection to one another.

A “semitone,” or “half step” refer to a smallest interval distance between two notes on a keyboard. It represents the direct distance between any two adjacent keys on a plano keyboard (e.g., white key to black key, or white key to white key). A semitone represents the pitch difference between two immediately adjacent notes and may be the ratio of the twelfth root of two in systems in which an octave is divided into twelve equal parts.

“Velocity” is intended to refer to the speed or force with which a musical note is struck or played. In MIDI systems, the velocity of a note is encoded as a value from 0 to 127. The velocity represents the intensity and loudness of a note. It may also be referred to as a “note intensity” or “key strike strength.”

An “attack” is intended to refer to how quickly a sound reaches its maximum volume. An attack may refer to an initial portion of the sound envelope.

A “growl” refers to a tonal characteristic or a byproduct of a playing technique. A growl (e.g., produced on an upright bass) may arise from a combination of factors, such as aggressive playing, low action (e.g., strings buzzing against frets), specific pickups, specific string material and specific fretboard material, and playing style. A growl refers to the sound quality and may result from articulations like digging in, attacking a string hard, or using vibrato to “work” a note. A “growl” can be described as an “angry” or “aggressive” tone that sits in the mid range of a bass (e.g., 500-4000 Hz) produces a “blooming” or “gritty” tone that adds interest to the sound.

“Hammer-on” may refer to a technique while playing a string instrument (e.g., an upright bass) in which a note is plucked with a plucking hand and, while the string is still vibrating, another note (e.g., a higher note) is played by forcefully pressing (“hammering”) a finger from the player's fretting hand on the same string. This technique creates a second note without plucking again, often resulting in a smoother, faster, and/or slightly softer sounding second note. Using this technique, the first note played is interrupted, while a second, higher note takes its place, creating a smooth, connected sound.

“Pull-off” may refer to a left-hand articulation technique for a string instrument (e.g., an upright bass) in which a second, lower note is produced on the same string as a previously articulated note by “flicking” or pulling a finger off a higher note, without plucking the string a second time.

A “slide” (also referred to as “portamento”) may refer to an articulation technique involving a smooth, continuous slide from one pitch to another. It may be used to bridge two notes without distinct, individual notes being heard in between the transition. As a non-limiting example, a slide on an upright bass may be sounded by gliding a finger along the string to move between two pitches, creating a continuous, smooth sound. A slide may be used to add emotional depth, often used to connect notes seamlessly or to slide into a target note from above or below, crucial for stylistic expression.

“Polyphonic behavior” is intended to refer to the playing of two or more notes of a virtual instrument at the same time/together. It is not necessarily the case that the notes were all initiated at substantially the same time. Polyphonic behavior allows for multiple notes to sound simultaneously, where the sounding of one note (e.g., a subsequent note) does not interrupt the sounding of another note (e.g., a previously sounded note).

“Monophonic behavior” is intended to refer to the playing of multiple notes, one at a time, where the playing of one note is interrupted by the playing of the next note.

An “inflection point” in MIDI (Musical Instrument Digital Interface) refers to a specific moment within a continuous controller (CC) curve or continuous pitch bend curve, from a controller or automation lane where the rate of change changes above a certain threshold. An inflection point may be the point where a data envelope or automation curve transitions sharply.

“NoteOn” is intended to refer to a MIDI event (e.g., a MIDI event in Scripter MIDI FX plugin) that signals the start of a musical note. In some embodiments, the NoteOn MIDI event may define the note's pitch (e.g., as a value between 1 and 127) and velocity (e.g., as a value between 1 and 127).

“NoteOff” is intended to refer to a MIDI event (e.g., a MIDI event in Scripter MIDI FX plugin) that signals the end of a musical note. In some embodiments, the NoteOff MIDI event may define the note's pitch (e.g., as a value between 1 and 127).

### Example Architecture

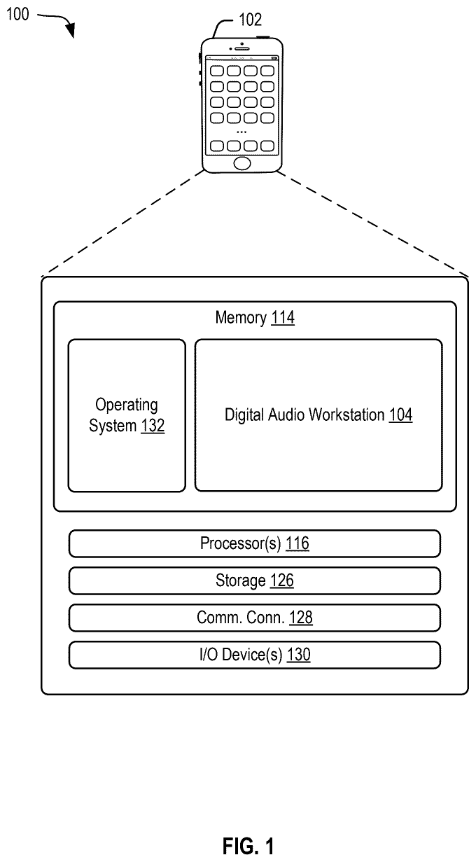

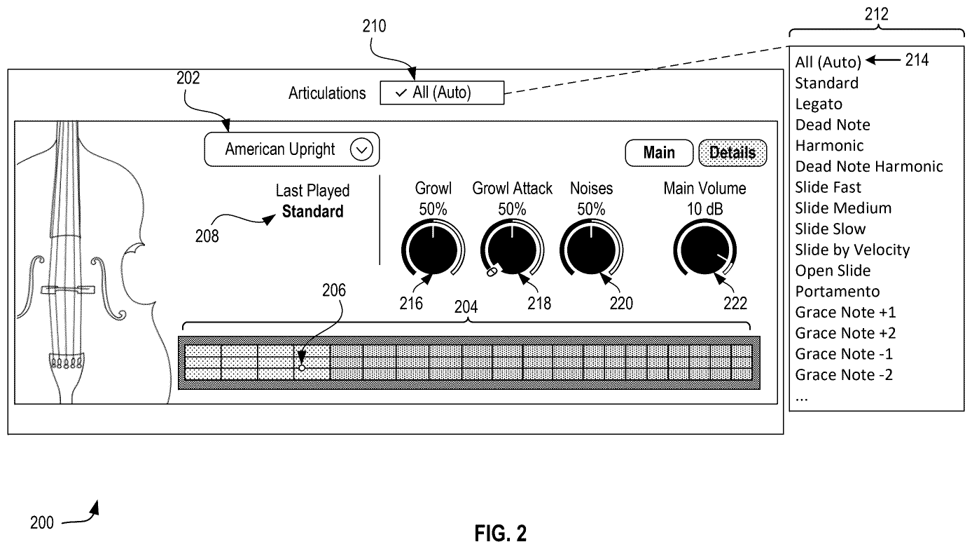

FIG. 1 is a simplified block diagram illustrating an example architecture (e.g., architecture 100) for implementing the virtual instrument techniques described herein, according to at least one embodiment. Architecture 100 may be used to implementing user interfaces (e.g., the user interface 200 of FIG. 2, etc.) and the various techniques disclosed herein, according to at least one embodiment. In some examples, a computing device (e.g., computing device 102) having the example architecture 100, may be configured to execute Digital Audio Workstation (DAW) 104, an example of a software application or an integrated hardware software system that may be used for recording, editing, mixing, and producing audio files (e.g., Logic Pro®, GarageBand®, and the like). Some of the features of DAW 104 may include the ability to record and layer multiple audio tracks simultaneously or sequentially, editing tools, MIDI support providing integration with MDI instruments and controllers for composing and arranging electronic music. Virtual mixing consoles for balancing levels, panning and applying effect to tracks, plugin integration to provide support for virtual instruments and audio effects, and control over parameters (e.g., volume, effects, panning) over time for dynamic changes in playback.

The computing device 102 may receive inputs (e.g., utilizing the I/O device(s) 130 such as a mouse, a MIDI controller, or the like) from a user at the user interface, communicates those inputs to a virtual instrument directly or to DAW 104 that hosts a virtual instrument (e.g., a plugin corresponding to a virtual instrument), and then presents audio output corresponding to the audio samples or synthesis in the virtual instrument utilizing the I/O device(s) 130 (e.g., a speaker of the computing device 102). The computing device 102 may be configured to modify audio samples according to the received inputs prior to presenting them as audio output.

The computing device 102 may be any type of computing device such as, but not limited to, a mobile phone (e.g., a smartphone), a tablet computer, a personal digital assistant (PDA), a laptop computer, a desktop computer, a thin-client device, a smart watch, a wireless headset, or the like.

In one illustrative configuration, the computing device 102 may include at least one memory 114 and one or more processing units (or processor(s)) 116. The processor(s) 166 may be implemented as appropriate in hardware, computer-executable instructions, or combinations thereof. Computer-executable instruction or firmware implementations of the processor(s) 166 may include computer-executable or machine-executable instructions written in any suitable programming language to perform the various functions described.

The memory 114 may store program instructions that are loadable and executable on the processor(s) 116, as well as data generated during the execution of these programs. Depending on the configuration and type of the computing device 102, the memory 114 may be volatile (such as random access memory (RAM)) and/or non-volatile (such as read-only memory (ROM), flash memory, etc.). The computing device 102 may also include additional removable storage and/or non-removable storage 126 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 114 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 614 and the additional storage 126, both removable and non-removable, are all examples of non-transitory computer-readable storage media. For example, non-transitory computer readable storage media may include volatile, or non-volatile, removable or non-removable media implemented in any method or technology for storage of information such as computer-readable instructions, data structures, program modules, or other data. The memory and the additional storage 126 are both examples of non-transitory computer storage media. Additional types of computer storage media that may be present in the computing device 102 may include, but are not limited to, phase-change RAM (PRAM), SRAM, DRAM, RAM, ROM, electrically erasable programmable read-only memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the computing device 102. Combinations of any of the above should also be included within the scope of non-transitory computer-readable storage media.

Alternatively, computer-readable communication media may include computer-readable instructions, program modules, or other data transmitted within a data signal, such as a carrier wave, or other transmission. However, as used herein, computer-readable storage media does not include computer-readable communication media.

The computing device 102 may also contain communications connection(s) 128 that allow the computing device 102 to communicate with a data store, another computing device or server, user terminals and/or other devices via one or more networks (not depicted). Such networks may include any one or a combination of many different types of networks, such as cable networks, the Internet, wireless networks, cellular networks, satellite networks, other private and/or public networks, or any combination thereof. The computing device 102 may also include I/O device(s) 130, such as a touch input device, a MIDI controller, a keyboard, a mouse, a pen, a voice input device, a display, a speaker, a printer, etc.

Turning to the contents of the memory 114 in more detail, the memory 114 may include an operating system 132 and/or one or more application programs or services for implementing the features disclosed herein such as DAW 104. The memory 114 may also be configured to store one or more audio samples to be used to produce audio output. In this way, the computing device 102 can perform all of the operations described herein, including implementing an entire virtual instrument application, without connection to any other computing devices or networks. For example, the virtual instrument application can be executed locally with locally stored samples.

In some examples, DAW 104 may be configured to manage one or more user interfaces. For example, DAW 104 may be configured to present user interface 200 of FIG. 2, or any suitable user interface for interacting with a virtual instrument, displaying data associated with such interactions, or the like. Additionally, in some examples, DAW 104 may be configured to receive and process user input corresponding to interactions with the virtual instruments. For example, a user may utilize a MIDI controller (e.g., a separate computing device communicatively connected to computing device 102) to provide user input with which the user may interact with a virtual instrument (e.g., user interface 200).

In some embodiments, DAW 104 may be configured to access a collection of stored audio samples (e.g., via the storage 126 of FIG. 1, or another suitable storage accessible to computing device 102). DAW 104 may be configured to identify a particular audio sample of the stored audio samples based on the provided user input. In some embodiments, DAW 104 may be configured to provide any suitable combination of the methods and techniques described herein with respect to FIGS. 2-18.

### Harmonic Sample Recombination

Sampled instrument playback is traditionally a process wherein various audio recordings are captured, and playback of these samples is triggered based on player input. Conventionally, MIDI sampled instrument playback works by using MIDI data (e.g., notes, velocity, duration) to trigger pre-recorded audio samples of the real instrument. When a key is pressed, the sampler maps that MIDI note to a specific recorded sound, adjusting its pitch and volume in real-time to create a realistic, playable instrument. Many samples are needed to improve playback realism. When the sample size is small, playback can sound repetitive and unrealistic, lacking in the nuanced playing features of live performances. However, utilization of a large sample set can result in a large memory footprints, often multi-Gigabytes in size.

A Harmonic Sampling Recombination (HSR) method (a sample modeling method) for virtual instruments is disclosed. The disclosed method includes obtaining fundamental and harmonic “layers” of various recorded samples and freely recombining them to produce varied, lifelike results that can be uniquely controlled by the user to produce a much more realistic playback result with a smaller memory footprint than traditional sampling methods. Using HSR, the fundamental frequency and the first few harmonics of a target instrument may be captured in one sample set while the upper harmonics are captured in a second. The different layers may be phase aligned to a common reference after which they can be freely recombined in various ways.

The disclosed techniques, systems, and methods enable control of the amplitude, tonal, and temporal components of the different layers separately. This allows a level of tonal flexibility that is far more advanced than conventionally found in MIDI-based virtual instruments, closer to the domain of pure synthesis virtual instrument methods. This malleability may be used to improve realism as well as allow the user access to useful customization controls.

Utilizing the following techniques provide a reduced memory footprint while providing enhanced playback realism. By way of example, conventional utilization of a sample size of 400 recorded samples enables a particular degree of variability with playback that corresponds to a degree of realism but often requires multiple Gigabytes of memory to store the samples. Utilizing the disclosed techniques can enable the same degree of realism with a fraction of the memory footprint utilized by conventional systems. By way of example, instead of storing 400 recorded samples as provided in the ongoing example, the disclosed techniques enable 20 samples per layer to be stored (e.g., 20 samples of a fundamental layer of 20 corresponding recorded notes and 20 samples of a harmonic layer of the recorded notes). Recombining these samples into different pairs of a fundamental layer audio sample and a harmonic layer audio sample provides 400 variations to be produced. However, the memory required to store the 40 samples of the fundamental/harmonic layer audio samples results in a memory footprint of around 150 megabytes, providing a substantially smaller memory footprint than the multi-Gigabyte footprints of conventional systems.

An example of utilizing the HSR method for providing enhanced virtual instrument techniques is discussed in further detail with respect to FIGS. 2-4.

FIG. 2 is a simplified block diagram illustrating an example user interface 200 for a virtual instrument (e.g., an American Upright Bass) that may be provided utilizing a computing device, according to at least one embodiment. User interface (UI) 200 may be one of a variety of user interface corresponding to various virtual instruments provided with a Digital Audio Workspace (DAW) (e.g., Logic Pro 11, etc.).

UI 200 may include selection element 202 which may be selected and utilized to identify one of a variety of versions of a musical instrument. By way of example, the DAW (or one or more plugins for the DAW that individually correspond to a virtual instrument) may provide a number of different versions of a virtual instrument (e.g., different versions of an upright bass). FIG. 2 depicts a selection of an American Upright Bass.

UI 200 may include playing area 204 which may be configured to present a visual representation of a playable interface of a virtual instrument. Playing area 204 may be configured to simulate/emulate the playable interface of a physical instrument. As depicted in FIG. 2, playing area 204 may simulate the fingerboard of an upright bass where notes are played by bowing or plucking the string(s), in some instances while pressing any suitable combination of strings down on the fingerboard.

While MIDI input is received (e.g., via a MIDI controller, not depicted), one or more indicators (e.g., indicator 206) may be presented in real time to indicate one or more notes within the playing area 204 that correspond to the MIDI input. As depicted, indicator 206 may depict a note corresponding to a particular press of a specific string on a fingerboard represented by playing area 204.

UI 200 may include indicator 208 which may be updated according to an articulation (e.g., a particular pre-defined style of the last-played note) which is used to influence the duration, intensity, and, if more than one note is played together or in series, the connection of those notes with respect to one another.

Selection element 210 may be provided via UI 200 to provide the user the option of selecting from a variety of pre-defined articulations or from an option to allow the system to determine the articulation to be used based at least in part on the MIDI data corresponding to the input provided at the MIDI controller. When selection element 210 is selected, menu 212 may be presented to enable a user to select from the pre-defined articulations corresponding to the selected virtual instrument (e.g., an American Upright Bass as selected at selection element 202). Selection of option 214 may correspond to a selection to allow the system to automatically determine the articulations to be used based at least in part on MIDI input data. The additional articulations depicted within menu 212 are intended to provide a set of articulation examples. Other pre-defined articulations, including additional, fewer, or different pre-defined articulations other than those depicted in menu 212 may be similarly used without departing from the scope of this disclosure.

A number of controls (e.g., controls 216-220) may be provided via UI 200 to enable user control of a number of tonal characteristics and/or playback features. UI 200 depicts the inclusion of control 216 which may be utilized to control an amount of “growl” provided in the resulting playback corresponding to the MIDI input data. A “growl” refers to a tonal characteristic or a byproduct of a playing technique. A growl (e.g., produced on an upright bass) may arise from a combination of factors, such as aggressive playing, low action (e.g., strings buzzing against frets), specific pickups, specific string material and specific fretboard material, and playing style. A growl refers to the sound quality and may result from articulations like digging in, attacking a string hard, or using vibrato to “work” a note. A “growl” can be described as an “angry” or “aggressive” tone that sits in the mid range of a bass (e.g., 500-4000 Hz) produces a “blooming” or “gritty” tone that adds interest to the sound. Control 216 may be utilized to modify the sample selected for the playback of a note to include these tonal characteristics. For example, manipulating control 216 (e.g., depicted as a knob in FIG. 2) to the left may cause a lesser degree of these tonal characteristics to be applied the sample providing playback of the note, while manipulating control 216 to the right may cause these tonal characteristics to be more prevalent in the provided playback, causing a larger degree of these tonal characteristics to be applied to the sample used to provide playback of the note.

Control 218 may be utilized to control the attack of a growl (e.g., how long the fade in is until the maximum level of the sound is reached). In other words, control 218 may be utilized to control how quickly the tonal characteristics of the growl (as selected by control 216) to the note being played back. Manipulating control 218 to the right may cause the immediacy of the application of the tonal characteristics of the growl to be lessened, resulting in the application of the growl tonal characteristics to be applied later (e.g., up to a predefined threshold period of time) after the start of the note playback, while manipulating control 218 to the left may cause the immediacy of the application of the tonal characteristics of the growl to be increased, resulting in the application of the growl tonal characteristics to be applied sooner (e.g., substantially immediately) after the playback of the note commences.

Control 220 may be utilized to control the amount of instrument handling noises that are applied to the playback of the note. Instrument handling noises for an upright bass are intended to include any suitable combination of left-hand (e.g., fretting) hand noises, right-hand (e.g., plucking) noises, instrument rattles/vibrations, physical handling noises, or the like. These noises simulating interaction with the real instrument may be added to the playback resulting from the MIDI input to simulate the instrument handling noises produced when playing a physical upright bass.

By way of example, left-hand noises may include fingerboard clicks/slaps (e.g., when the string vibrates against the fingerboard, creating a “clack” or “click” sound), string/finger noise (e.g., the sounds of finger(s) moving, sliding, or shifting on the strings, producing a sliding “screech” or scratching sound), a “lift buzz” (e.g., a faint buzz that occurs when the left-hand finger is lifted from the string before the next note is played, often heard in fast passages), unwanted harmonics (e.g., a slight chime produced when lifting the finger too slowly, allowing the string to vibrate at a harmonic point rather than stopping instantly), or the like.

Right-hand noises may include string slapping (e.g., when the right-hand intentionally slaps the string against the fretboard, sometimes referred to as a “percussive clack”), rosin dust/crunch (e.g., a crunchy, scratching sound produced if the bow has too much or unevenly applied rosin, bow growl or scratch (e.g., a low-pitched, gritty roar caused by the bow), double stop accidents (e.g., when two strings are accidentally hit with the bow when only one string was intended, creating a discordant, harsh tone), or the like.

Instrument rattles and vibrations may include simulations of a loose endpin (e.g., a common source of rattling buzz if the endpin is not tightened firmly, causing it to vibrate inside the bass), pegbox/tuner rattles (e.g., vibrations from loose tuners or strings rattling against the pegbox, often appearing as a high-pitched, metallic buzz), open seams (e.g., if the glue joints holding the top or back to the ribs loosen, they can produce a persistent, buzzing rattle), internal debris (e.g., small bits of wood or hardened blue inside the body, commonly referred to as “sound post debris” can vibrate and create a rattle), or the like.

Physical handling noises may include instrument shifting (e.g., the sound of the instrument moving against a player's body), endpin slippage (e.g., the sound of the endpin sliding across a floor, particularly if not using a rubber tip).

Control 222 may be manipulated to control the overall volume of the virtual instrument playback. Control 222 may be used to control the dynamics of the virtual instrument to vary playback from soft to loud.

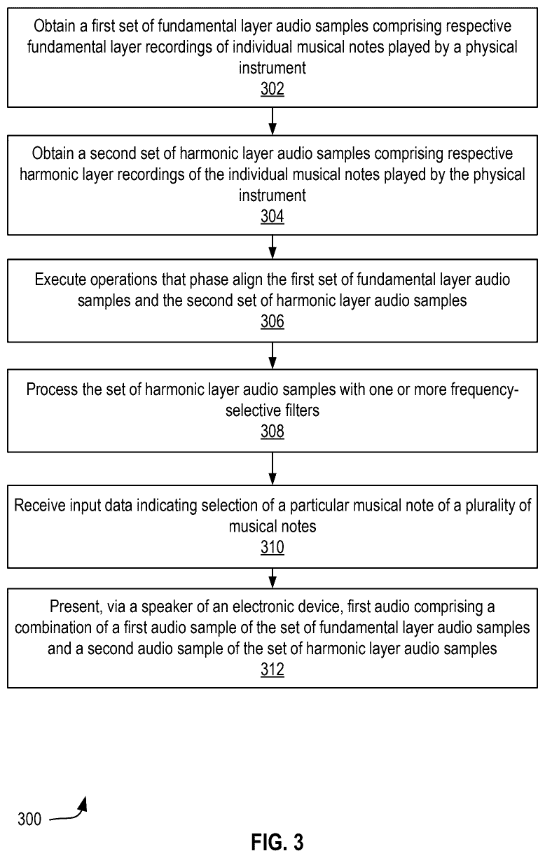

FIG. 3 is a simplified flow diagram illustrating an example method 300 for enhancing realism of virtual instrument playback as described herein, according to at least one example. Method 300 illustrates as logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement method 300.

Additionally, some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium is non-transitory.

In some examples, method 300 may be performed by the computing device 102 of FIG. 1. In some examples, the computing device may comprise a memory configured to store computer-executable instructions, a speaker, and a processor in communication with the memory and the speaker, the processor configured to execute the computer-executable instructions.

Method 300 may begin at 302, where a first set of fundamental layer audio samples comprising respective fundamental layer of recordings of individual musical notes played by a physical instrument may be obtained. In some embodiments, the physical instrument may be set up and adjusted to produce the darkest, most fundamental rich tone possible prior to recording various samples of musical notes. This may include making modifications to the physical instrument itself. Multiple recordings may then be made for all relevant playing styles, dynamic levels, and pitches. These recordings may be referred to a “fundamental layer audio recordings.”

At 304, a second set of harmonic layer audio samples comprising respective harmonic layer recordings of the individual musical notes played by the physical instrument may be obtained. In some embodiments, a physical instrument may be set up in its natural state and the same musical notes captured at 302 may be recorded. These recordings may be focused on the bright and lively variations that the physical instrument is capable of. Multiple recordings may then be made for all relevant playing styles, dynamic levels, and pitches. These recordings may be referred to a “harmonic layer audio recordings.”

In some embodiments, if the audio samples described at 302 and 304 are captured in a session recording with multiple notes, the recording may be separated into multiple samples where each sample includes a single sound (e.g., a single sound and no others). These samples may be organized by pitch, playing style/articulation, and dynamic level.

At 306, operations may be executed to phase align the first set of fundamental layer audio samples and the second set of harmonic layer audio samples. By way of example, a pitch offset and excess pitch variation may be removed from individual samples manually, or by using any suitable processing techniques (e.g., pitch correction software). As discussed above, “phase” refers to where a periodic audio waveform is in its cycle at a given time and “phase alignment” refers to a process of ensuring (e.g., via modification or validation) that two or more audio waveforms have the same pitch and phase so that they reinforce each other positively when combined. For any given sample, pitch may not vary to the point of going into an anti-phase state from beginning to end relative to a common reference oscillator. This allows any two samples from a given layer (e.g., one fundamental and one harmonic) to be combined together without causing any phasing or chorusing issues. Phase alignment may include aligning pitch between the two samples so that the samples not only start at the same time but are also played at the exact same pitch so that their respective wavelength peaks and troughs remain aligned throughout the entire duration of the sound.

At 308, the set of harmonic layer audio samples may be processed with one or more frequency-selective filters. In some embodiments, the one or more frequency-selective filters comprise a hipass filter and/or one or more notch filters. In some embodiments, the harmonics layer audio sample may be processed to reduce frequency buildup that would otherwise occur when it is played alongside a fundamental layer audio sample. When recording bright sounds from an instrument the fundamental frequency and the first few harmonics of a note will naturally still exist. These may be removed to allow the harmonic layer audio samples to stack correctly with the fundamental layer audio samples. This may include processing the harmonic layer audio sample with a hipass and/or notch filter(s). A “hipass filter” is intended to refer to an audio tool that attenuates frequencies below a set threshold while allowing higher frequencies to pass through. A “notch filter” (sometimes referred to as a “band-stop filter” or “band-reject filter”) is intended to refer to a specialized equalizer (EQ) tool that may act as a narrow-band rejection filter, designed to remove specific, unwanted frequencies (e.g., high-pitched ringing, hums, or resonances), without affecting the surrounding audio. In some embodiments, a hipass filter may be tuned to remove all harmonics below a given turnover frequency (e.g., a predefined frequency value). In some embodiments, notch filter(s) may be tuned to remove individual harmonics that are also present in the fundamental layer sample corresponding to the same musical note.

Once all samples have been recorded and processed, they can be set up for recombined playback so that each time a note is played on a MIDI controller, two samples will play back instead of one. For example, the playback of the note may include a fundamental layer audio sample and a harmonic layer audio sample. In some embodiments, sample selection may be randomized on a per layer basis so that for an incoming MIDI note (e.g., corresponding to MIDI input data) of any given pitch and loudness, one of multiple different variation samples will be triggered.

At 310, input data (e.g., MIDI input data) may be received indicating selection of a particular musical note of a plurality of musical notes.

At 312, based at least in part on the input data received at 310, first audio comprising a combination of a first audio sample of the set of fundamental layer audio samples and a second audio sample of the set of harmonic layer audio samples may be presented at a speaker of an electronic device. In some embodiments, the particular fundamental layer audio sample and/or the particular harmonic layer audio sample may be selected randomly from the respective sets of available samples. As described above, upon receiving the input data (e.g., MIDI input data indicating a MIDI note) a fundamental layer audio sample and a harmonic layer audio sample may be selected from the prerecorded/processed samples and combined before being presented. In some embodiments, the fundamental layer audio sample may play back in a predictable manner, but the upper harmonic layer audio sample may be triggered and adjusted in various ways to produce greater realism and flexibility. By way of example, in some embodiments, the offset volume of the harmonic layer audio sample may be adjusted from inaudible to overtly loud to vary brightness and liveliness of the note. As another example, an amplitude envelope (e.g., a description of how the volume/amplitude of a sound changes over time including attack, decay, sustain, and release) can be varied to create swells, crescendos, or different playing emphasis of the playback.

In some embodiments, method 300 may include modifying an amplitude component, a tonal component, or a temporal component of the first set of fundamental layer audio samples and/or the second set of harmonic layer audio samples.

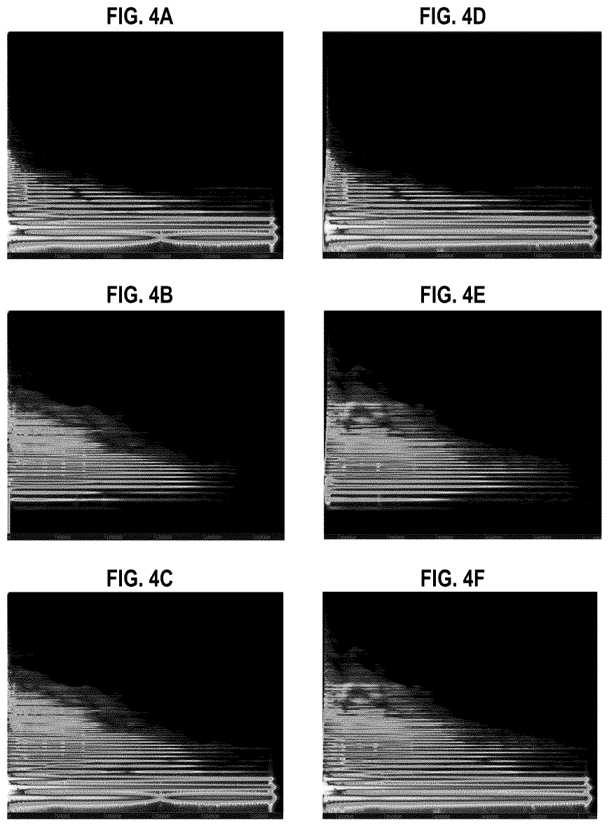

FIGS. 4A-4F depicts a number of graphs that illustrate example fundamental and harmonic layers and corresponding combinations thereof, according to at least one embodiment. Each of the graphs depict an x axis in the horizontal direction that indicates time and a y axis in the vertical direction that indicates frequency. FIG. 4A depicts a fundamental layer audio sample of a recorded note. FIG. 4B depicts a harmonics layer audio sample of the same note (e.g., a different recording, or portion of the same recording, of the same note). FIG. 4C depicts the combination of the fundamental layer audio sample of FIG. 4A with the harmonic layer audio sample of FIG. 4B.

Similarly, FIG. 4D depicts a fundamental layer audio sample of a recorded note. FIG. 4E depicts a harmonics layer audio sample of the same note (e.g., a different recording, or portion of the same recording, of the same note). FIG. 4F depicts the combination of the fundamental layer audio sample of FIG. 4D with the harmonic layer audio sample of FIG. 4E.

### Techniques for Enhancing Fixed-Length Slide Realism

Portamento, with respect to virtual instruments, refers to an automatic bending from one note to another when two notes overlap. Bending notes (also referred to as “sliding”) on a virtual instrument (e.g., the American Upright Bass corresponding to FIG. 2) is a desirable playing articulation which may be automatically or manually selected (e.g., via menu 212 of FIG. 2). A “slide” as discussed herein, may also be referred to as a portamento. Both terms are intended to refer to a musical technique involving a smooth, continuous slide from one pitch to another.

To enhance portamento realism, two sound layers may be triggered during the slide: a finger slide (e.g., an audio sample referred to as a “finger slide audio sample” that includes the sounds of the fingers zipping across the string) and a hand slide (e.g., an audio sample referred to as a “hand slide audio sample” that include the sounds of a hand sliding along the back of a wooden neck of an upright bass). Both the finger slide and the hand slide may be examples of an “effects sample” (also referred to as an “FX sample”) which may be a pre-recorded audio file that is designed to add texture, atmosphere, transition, or impact to a music production. FX samples may include non-melodic, processed sounds that may be used to fill space or enhance the production value of a track.

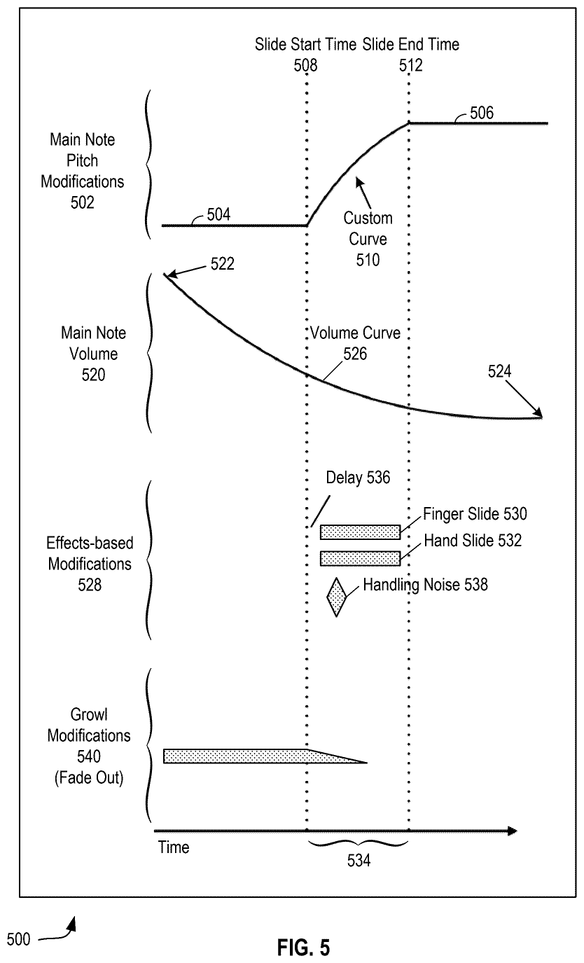

FIG. 5 is an illustration of example modifications (modification 500) to be made to audio output to provide enhanced fixed length slide realism for a slide (also referred to as a “portamento”), according to at least one embodiment.

Modifications to the pitch of the main note is depicted at 502. The pitch of the main note may be modified from a first pitch corresponding to the pitch of a first note (depicted at 504) to a second pitch corresponding to the pitch of a second note (depicted at 506). At the beginning of the slide starting at start time 508, the note's pitch may be modified to the pitch of the second note based on a custom curve (e.g., custom curve 510) through a time period between the slide start time 508 and the slide end time 512. It should be appreciated that although the depiction of FIG. 5 implies an upward slide in which the pitch of the second note is higher than the pitch of the first, main note, a slide may similarly be applied when the pitch of the first, main note is higher than the pitch of the second note on which the slide ends. The latter may be referred to as a “downward slide.”

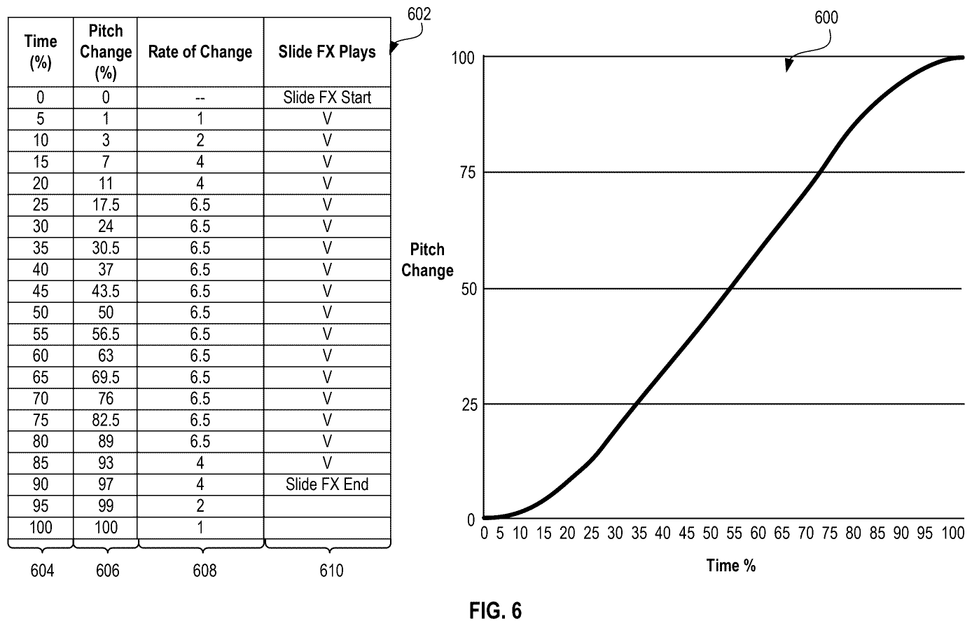

FIG. 6 depicts a graph (e.g., graph 600) and corresponding table (e.g., table 602) illustrating pitch changes of a slide based on time estimating a real player's motion, according to at least one embodiment. The x axis of graph 600 may represent the percentage of time through the slide (e.g., a Portamento slide), and the y axis of graph 600 may represent the amount of pitch change (e.g., in percentage representing the percentage of change achieved of the difference between a pitch of the first, main note, and the second note on which the slide ends.

Column 604 of table 602 represents the percentage of time that has transpired between the start time of the slide (e.g., slide start time 508 of FIG. 5) and the end time of the slide (e.g., slide end time 512 of FIG. 5).

Column 606 of table 602 represents the percentage of pitch change that has been applied (e.g., the percentage of the total pitch change represented by the difference between the pitch of the first note and the pitch of the second note) between the start time of the slide (e.g., slide start time 508 of FIG. 5) and the end time of the slide (e.g., slide end time 512 of FIG. 5).

Column 608 of table 602 represents a rate of pitch change at a given point on graph 600.

Column 610 of table 602 represents portions of the slide during which one or more FX samples may be played. Column 610 indicates that one or more FX samples (e.g., corresponding to a finger slide audio sample and/or hand slide audio sample) may be played for the first 90% of a portamento slide.

Returning to FIG. 5, example modifications to the main note's volume are depicted at 520. The note's volume may be highest at the start of the main note (depicted at 522) and lowest at 524 (at the end of playback), while following the curve depicted at 526. Curve 526 is intended to represent a note's “decay curve” which is intended to refer to the natural shape of the volume of the main note audio sample.

Effects-related modifications may be depicted at 528 and may include any suitable combination of playing a finger slide audio sample, a hand slide audio sample, or an audio sample including instrument handling noise (e.g., audio including any suitable combination of Instrument handling noises for an upright bass such as left-hand (e.g., fretting) hand noises, right-hand (e.g., plucking) noises, instrument rattles/vibrations, physical handling noises, or the like. Examples of these instrument handling noises have been provided above and are not repeated here, for brevity.

As depicted in FIG. 5, finger slide 530 (e.g., an audio sample including recorded finger sliding sounds) and hand slide 532 (e.g., an audio including hand sliding sounds) may be played during the slide, between slide start time 508 and slide end time 512. In some embodiments, finger slide 530 and hand slide 532 may be played at the same time. In some cases (e.g., if the slide length of the slide (e.g., duration 534, representing the time period between slide start time and slide end time 512) is greater than a threshold value (e.g., greater than 900 milliseconds (ms)), a delay may be utilized (e.g., delay 536) to offset the start of playback of the finger slide and the hand slide 532 from the start of the slide (e.g., slide start time 508). This may be the case when the recordings of finger slide 530 and hand slide 532 are less than one second. For substantially longer slides (e.g., slides with a duration that is greater than a predefined threshold such as one second), playing the finger slide 530 and hand slide 532 may produce a more realistic production when played within the middle of the slide.

By way of example, if the slide length is >900 milliseconds (ms), delay 536 (D) may be determined based on the following equation:

$$D = \frac{SlideLength}{2} - 500 milliseconds ( ms )$$

Otherwise, the delay D may be set to 0.

In some embodiments, handling noise 538 (e.g., an audio sample including one or more instrument handling noises) may be played a portion of the way through the slide. In some embodiments, handling noise 538 may be played beginning at a predefined percentage of the way through the slide (e.g., once 20% of the duration 534 has elapsed).

In some embodiments, the velocity of the FX samples (e.g., finger slide 530, hand slide 532, and/or handling noise 538) may be modified based on the decay curve of the note being bent, the slide length (e.g., duration 534), and/or one or more offsets.

In some cases, it may be desirable for the velocity of these FX samples to match the instrument's volume at the point in time that they get triggered. As depicted at 520, the note of a slide may already be decaying (e.g., according to curve 526) and the slide is simply bending an already existing decaying note. In this scenario, the decay curve of the main note (e.g., represented by curve 526) may be used to determine the velocity of these FX samples (also referred to as “slide effects”), depending on when they trigger within that decay curve. In some embodiments, the core note's decay curve may be used, but scaled so that the minimum velocity of the FX sample(s) is half of the main note's initial velocity at the time the FX sample begins playback.

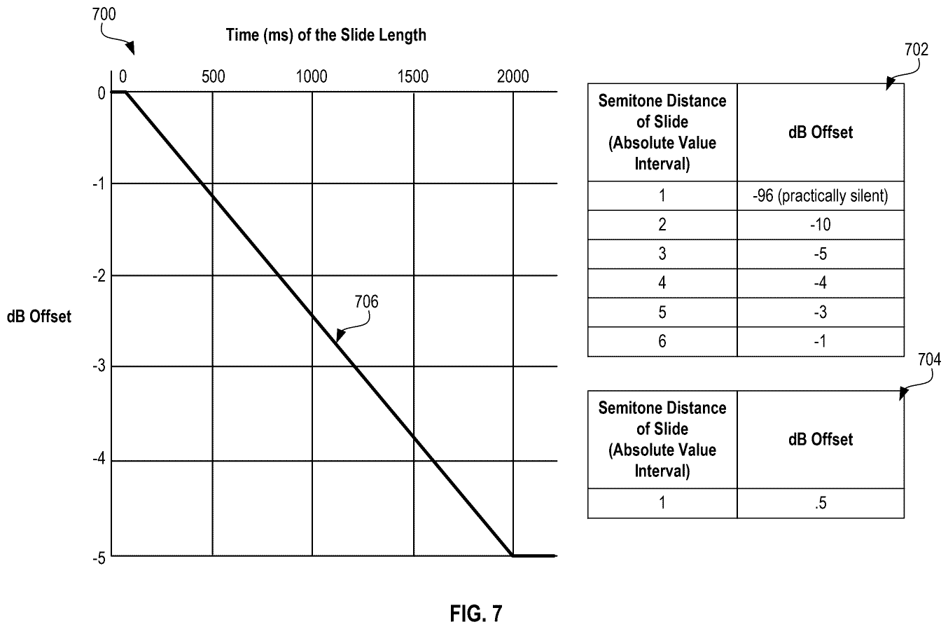

The slide length may also (or alternatively) be used to affect the velocity of the FX sample(s) played during the slide. In some embodiments, and in some cases after the velocity of the FX sample(s) are modified based on the decay curve of the note, the velocity may be offset according to the curve in graph 700 of FIG. 7

FIG. 7 depicts a graph (e.g., graph 700) and tables (e.g., table 702 and table 704) illustrating dB offset values depending on the slide length of a fixed length slide (e.g., a portamento), according to at least one embodiment. Table 702 is intended to depict dB offsets for finger slides (e.g., finger slide 530 of FIG. 5). Table 704 is intended to depict a dB offset for hand slides (e.g., hand slide 532 of FIG. 5).

Graph 700 may include an x axis that represents the slide length time (e.g., the duration of the slide, represented by duration 534 of FIG. 5) in milliseconds. The y axis of graph 700 is intended to depict the dB offset which may be applied to the velocity of the FX sample (e.g., the velocity determined for the FX sample(s) based at least in part on the decay curve of the core note). A “dB offset” is intended to refer to a fixed adjustment made to a measured or calculated velocity level, shifting the value up or down by a set amount in decibels (dB). The velocity offset may be achieved through converting the dB offset to an offset in velocity units, according to the instrument's dynamic range (e.g., the dynamic range of 0 to −30 decibels (dB)). In some embodiments, curve 706 may be represented by the following piecewise function:

$$y = \{ 100 < x < 2000 : - ( \frac{1}{380} ) x \}$$

$$y = \{ x \leq 100 : 0 \}$$

$$y = \{ x \geq 2000 : - 5 \}$$

In some embodiments, after the velocity of the FX sample(s) have been modified based on the decay curve of the core note and the dB offset identified from curve 706 of graph 700, the velocity of a finger slide (e.g., finger slide 530) may be offset based on table 702. Table 702 maps the distance in semitones (e.g., half steps) of the slide (e.g., the semitones in the interval between the first pitch 504 and second pitch 506 of FIG. 5) to a dB offset. Table 702 indicates that the larger the distance in pitch the note slides, the louder the finger slide sample will sound.

In some embodiments, after the velocity of the FX sample(s) have been modified based on the decay curve of the core note and the dB offset identified from curve 706 of graph 700, the velocity of a hand slide (e.g., hand slide 532) may be offset based on table 704. Table 702 maps the distance in semitones between the first pitch and the second pitch (e.g., the first pitch 504 and second pitch 506 of FIG. 5) to an offset value.

Returning to FIG. 5, a variety of finger slide and hand slide samples may be organized into many groups (e.g., by duration and by which string they were sampled from). The finger slide and hand slide samples utilized may be randomly selected from the appropriate group that corresponds to the slide length (e.g., duration 534) and the string corresponding to the string from which the note is sounded.

In some embodiments, handling noise 538 may be played at a predefined percentage of the way through the total slide duration (e.g., 20% of duration 534). In some embodiments, handling noise 538 may be limited to be between a predefined range of durations (e.g., between and 200 ms). In some embodiments, the velocity of handling noise 538 may be offset by a predefined dB offset (e.g., −7 dB), using the velocity-dB conversion (e.g., the instrument's dynamic range of 0 to −30 decibels (dB)) from the primary note's original velocity.

As depicted by growl modifications 540, in embodiments in which a growl layer is presented (e.g., an audio recording of a growl articulation provided at a physical instrument), the growl layer (e.g., growl audio sample being presented) may be faded out over a predefined duration (e.g., 224 ms, or the like) from the slide starting time (e.g., time 508).

### Blending Monophonic and Polyphonic Behavior

When using virtual instruments within a Digital Audio Workstation (DAW) (e.g., such as Logic Pro, etc.), there may be different modes offered that dictate how many notes can be played at the same time. The usual modes are “monophonic,” referring to a mode that results in one note being played at a time, and “polyphonic,” referring to a mode that allows any number of notes to be played together.

In idiomatic playing of the upright bass, there are certain combinations of notes that are usually played monophonically (with new notes interrupting previous notes) and other situations that are played polyphonically (with multiple notes sounding at once). Three example combinations of notes simulate articulations that are idiomatic to upright bass playing, such as “hammer-on,” “pull-off,” and slides, all of which may be monophonic examples (articulations that utilize notes that play one note being played at a time). “Hammer-on” refers to an articulation often heard when a new note is played which is one or two pitches (adjacent) above a current note. In this situation, a player often “hammers on” their finger to the fret board to make the new note sound. When the new note is one or two pitches (adjacent) below a current note, a player often “pulls off” their finger from the fret board to make the new note sound. When a new note is within a threshold number of pitches away (e.g., seven semitones away) from a current note, a player can also slide their hand along the string to bend the current note to the new note.

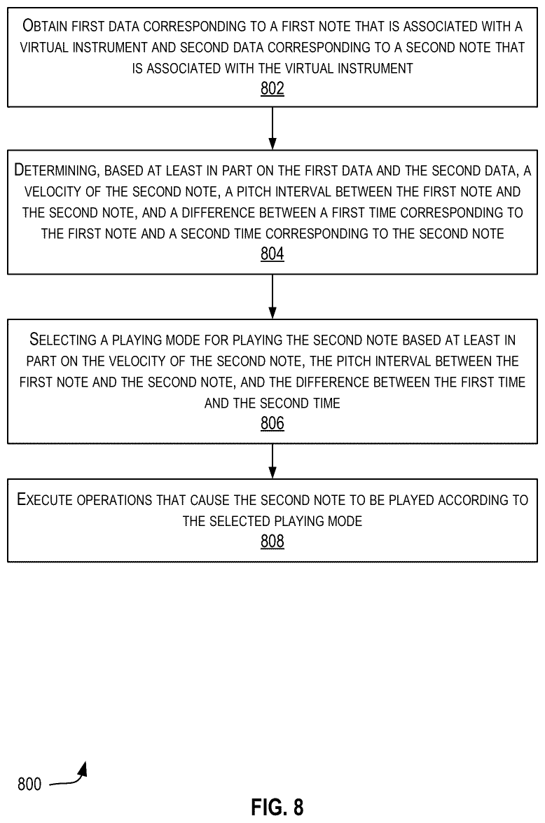

An automatic playing mode that blends the monophonic and polyphonic behavior together depending on the situation is desirable but missing from conventional systems. The disclosed techniques, specifically, the method of FIG. 8, are intended to support these idiomatic styles of playing without a user needing to manually choose the behavior.

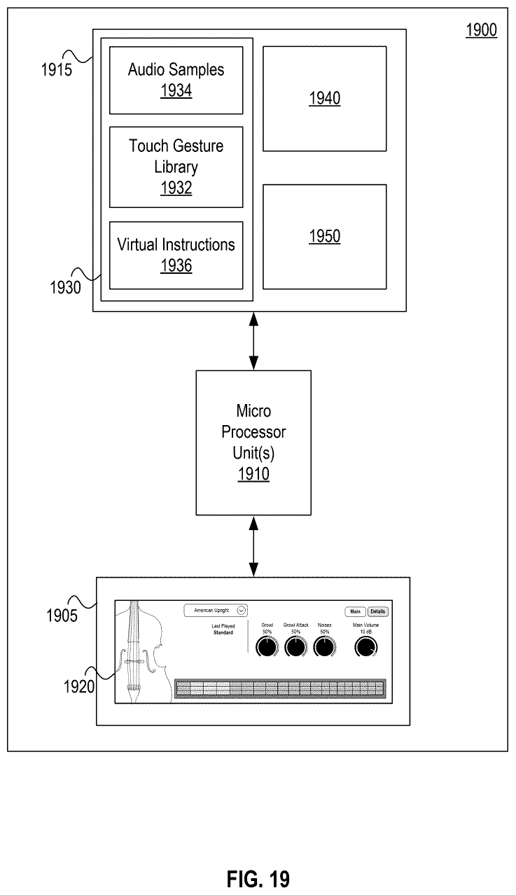

The disclosed system (e.g., system 1900 of FIG. 19, DAW 104 of FIG. 1, or the like), may be configured to blend monophonic and polyphonic behavior depending on the situation. In some embodiments, the system uses a contextual query of the instrument's state information to decide whether to act monophonically or polyphonically. For two sequential notes, the state information used may be the interval between notes, the timing between notes, the time elapsed of the first note, and the velocity of the second note.

In some embodiments, for two sequential notes, polyphonic behavior may be overridden (and monophonic behavior enforced) if: 1) the velocity of the second note is greater than a threshold value (e.g., 70), 2) the interval between the two notes is within two half steps, and 3) the timing between the two notes is greater than a predefined chord window (e.g., a predefined timing threshold). In some embodiments, if the start times of two or more notes fall within the predefined timing threshold of the start time of the first note (or a previous note) the system is configured to play to the notes as a chord (that is, polyphonically together), versus playing the notes one at a time, where one note interrupts the sounding of a previous note.

As another example, for two sequential notes, polyphonic behavior may be overridden (and monophonic behavior enforced) if: 1) the velocity of the second note is less than a threshold value (e.g., 70), 2) the interval between the two notes is within seven half steps, 3) the timing between the two notes is greater than a predefined chord window (e.g., a predefined timing threshold), and 4) the timing between the two notes is less than a predefined percentage (e.g., 30%, etc.) of the length of the first note.

FIG. 8 is a simplified flow diagram illustrating another example method (e.g., method 800) for enhancing realism of virtual instrument playback as described herein based on blending monophonic and polyphonic behavior, according to at least one example. Method 800 illustrates as logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement method 800.

Additionally, some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium is non-transitory.

In some examples, method 800 may be performed by the computing device 102 of FIG. 1. In some examples, the computing device may comprise a memory configured to store computer-executable instructions, a speaker, and a processor in communication with the memory and the speaker, the processor configured to execute the computer-executable instructions.

In some embodiments, method 800 may be used to select a playing mode for playing a note of a virtual instrument corresponding to a physical instrument. Method 800 may begin at 802, where first Musical Instrument Digital Interface (MIDI) data corresponding to a first note that is associated with the virtual instrument and second MIDI data corresponding to a second note that is associated with the virtual instrument may be obtained. In some embodiments MIDI data may include any suitable combinations of values indicating pitch, velocity, timing, control sound parameters (e.g., modulation wheels, faders, knobs, etc.), pitch bend signals, or the like.

At 804, a velocity of the second note, a pitch interval between the first note and the second note, and a difference between a first time corresponding to the first note and a second time corresponding to the second note may be identified. In some embodiments, the velocity of the second note, the pitch interval between the first note and the second note, and the difference between a first time corresponding to the first note and a second time corresponding to the second note may be identified based at least in part on the first MIDI data and the second MIDI data.

At 806, the playing mode for playing the second note may be selected based at least in part on the velocity, the pitch interval, and the difference between the first time and the second time that was identified at 804. In some embodiments, the playing mode may be selected from 1) a first playing mode (e.g., a polyphonic mode) that, when utilized, causes the second note to sound while the first note is sounding or 2) a second playing mode (e.g., a monophonic mode) that, when utilized, causes the first note to be interrupted with the second note.

At 808, operations may be executed that cause the second note to be played according to the playing mode selected at 806.

Although not depicted in FIG. 8, the method 800 may further comprise determining a duration that the first note has been played. In some embodiments, the playing mode for playing the second note is selected further based at least in part on the duration that the first note has been played.

In some embodiments, the second playing mode (e.g., a monophonic mode) for playing the second note is selected based at least in part on: 1) determining, from the second MIDI data, that the velocity of the second note falls below a predefined velocity threshold value, 2) determining, based at least in part on the first MIDI data and the second MIDI data, that the pitch interval between the first note and the second note falls below a predefined interval threshold, 3) determining, based at least in part on the first MIDI data and the second MIDI data, that the difference between the first time corresponding to the first note and the second time corresponding to the second note exceeds a predefined timing threshold, and 4) determining, that the difference between the first time and the second time is less than a portion of the duration of the first note. In these embodiments, the predefined velocity threshold value is seventy, and the predefined interval threshold corresponds to seven half steps.

In some embodiments, the second playing mode (e.g., a monophonic mode) for playing the second note is selected based at least in part on: 1) determining, from the second MIDI data, that the velocity of the second note meets or exceeds a predefined velocity threshold value, 2) determining, based at least in part on the first MIDI data and the second MIDI data, that the pitch interval between the first note and the second note exceeds a predefined interval threshold, and 3) determining, based at least in part on the first MIDI data and the second MIDI data, that the difference between the first time corresponding to the first note and the second time corresponding to the second note exceeds a predefined timing threshold. In these embodiments, the predefined interval threshold may correspond to two half steps.

In some embodiments, the first playing mode is a default playing mode, and wherein selecting the second playing mode causes the default playing mode to be overridden.

### Motion Prediction for Continuous MIDI Controller Data

Besides note events, virtual instruments also accept continuous controller MIDI data such as pitch bend and MIDI CC (e.g., Continuous Controller or Control Change) events. In some embodiments, MIDI CC events may include MIDI messages that may be used to alter sound parameters in real time, such as volume, panning, or modulation, within a Digital Audio Workstation (DAW). Bending notes on an upright bass is a common technique, and the disclosed techniques may enable users to achieve this playing technique through pitch bend. To create realistic bends, more than the bending of the main note may be necessary. For example, other auxiliary sounds may also play a crucial role. Sound layers of the hand moving on the instrument neck and the finger zipping across the string (collectively included in “handling noise(s)”) may be needed to make the bends sound real. In some embodiments, the continuous pitch bend data may be processed to determine when these auxiliary sounds should be triggered and stopped, as well as which specific sound samples to use (e.g., based on the direction of the controller).

The disclosed system may be configured to generate four types of events based on continuous MIDI data: started moving (up/down), stopped moving (up/down), stable, and stable moving (slow enough to be stable). The system may determine inflection points in the continuous controller data through smoothing the data and calculating first and second derivatives of the data. After an inflection point is detected, the controller data may be monitored for a period of time (e.g., 50 ms, or the like), and a direction and slope prediction may be determined from data of that window (e.g., the data obtained from the time period corresponding to the 50 ms). The motion may be categorized into the four types mentioned above (e.g., started moving, stopped moving, stable, and stable moving. These categories may be used to trigger/mute auxiliary sounds (e.g., depending on changes in motion in continuous controller data).

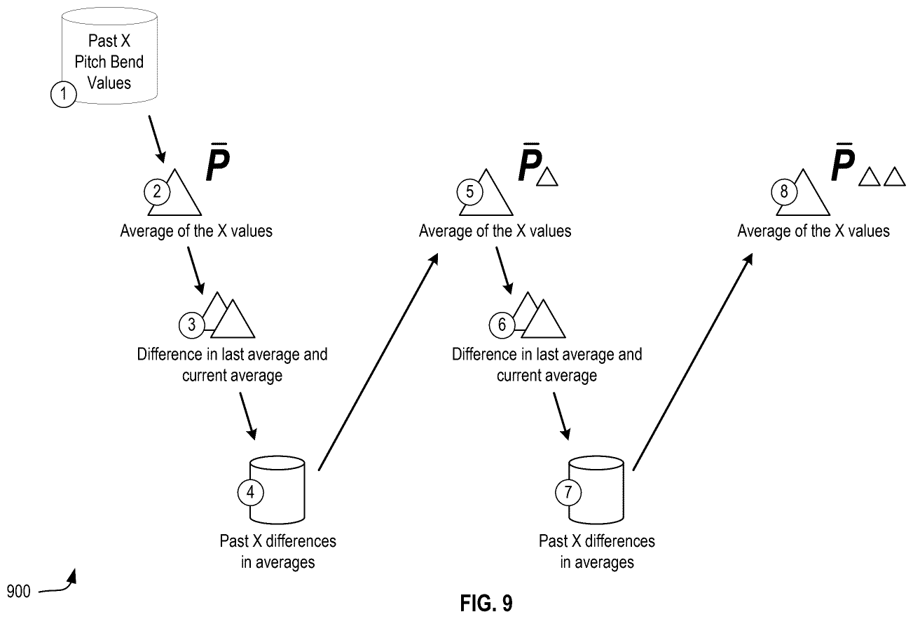

FIG. 9 is an illustration of a method (e.g., method 900) for gaining information regarding inflection points, according to at least one embodiment. Method 900 illustrates a logical flow diagram, each operation may represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement method 900.

Additionally, some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium is non-transitory.

In some embodiments, every pitch bend event may be collected and processed in a system that smooths the events and calculates differentials in order to gain information about inflection points and when the data changes directions. Method 900 may cause a number of moving averages to be calculated as described below.

The method 900 may begin at step 1, where the past X (e.g., 3, 4, 6, etc.) number of pitch bend values may be collected. This set may be referred to as “set 1.”

At step 2, an average of the values of set 1 may be calculated. This average may be referred to as “P̅.”

At step 3, a difference in the last average (e.g., the last calculated average of pitch bend values) and the current average (e.g., the average calculated at step 2) may be calculated.

At step 4, the difference may be added to a set including the past X (e.g., 3, 4, 6, etc.) differences in averages. This set may be referred to as “set 2.”

At step 5, an average of the values of set 2 may be calculated. The average of the last X differences in averages may be referred to as “P̅_{Δ}

At step 6, a difference in the last calculated P̅_{Δ} and the last calculated P̅_{Δ} may be calculated.

At step 7, the difference calculated at step 6 may be added to a set including the past X (e.g., 3, 4, 6, etc.) differences in averages. This set may be referred to as “set 3.”

At step 8, an average of the values of set 3 may be calculated. The resultant value may be referred to as “P̅_{ΔΔ}

As a non-limiting example, P̅ may be the average of the last 3 pitch bend events (e.g., the values of set 1), P̅_{Δ} may be the average of the last 3 difference in averages (e.g., the values of set 2), and P̅_{ΔΔ} may be the average of the last 3 difference in averages in the last 3 differences in averages (e.g., the values of set 3).

In some embodiments, a record of the last and current value of each of these values may be maintained and denoted by [1] for last, and [c] for current. For example, P̅_{ΔΔ}[l] may be the last P̅_{ΔΔ} value and P̅_{ΔΔ}[c] may be the current P̅_{ΔΔ} value.

In some embodiments, an inflection point, I, may be defined by the following Boolean equation:

I=[(|P̅_{ΔΔ}[c]|>T_{ΔΔ}) and [|P_{ΔΔ}[l]|≤T_{ΔΔ})]

or [(|P̅_{ΔΔ}[c]<T_{ΔΔ}) and [(|P̅_{ΔΔ}[l]|≥T_{ΔΔ})

where T_{ΔΔ} is a predefined threshold (e.g., 3, 4, etc.). In other words, when the absolute value of P̅_{ΔΔ} crosses over a predefined threshold, T_{ΔΔ}, in either direction, an inflection point may be identified.

After an inflection point has occurred, there may be a window (e.g., a 50 ms window) in which any incoming pitch bend events may be monitored and a slope measurement may be accumulated. Within that window, another inflection cannot take place. At the end of the window, the slope S may be calculated using the following equation (e.g., the average of all P̅_{Δ} for each event in the window after the inflection point):

S=avg(P̅_{Δ1},P̅_{Δ2}, . . . )

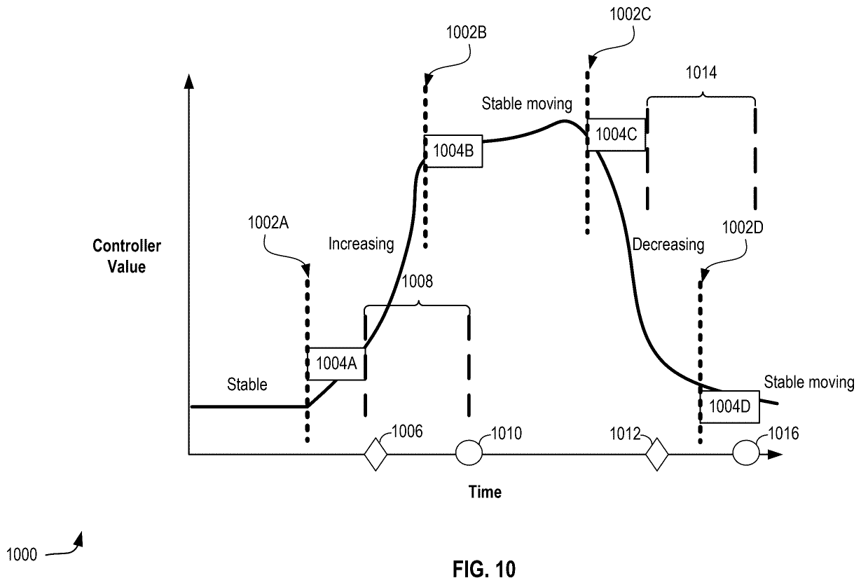

FIG. 10 is a graph (e.g., graph 1000) representing a number of inflection points (e.g., inflection points 1002A-D, collectively referred to as “collection points 1002”), according to at least one embodiment. The x axis of graph 1000 is intended to represent time, while the y axis of graph 1000 is intended to represent a corresponding controller value.

As discussed above, MIDI controller motion can be categorized into a number of states (e.g., stable moving, increasing, and decreasing). At least one of each of these states is depicted in the graph 1000. By way of example, the state of MIDI controller motion prior to inflection point 1002A may be identified as corresponding to a stable state. The state of MIDI control motion between inflection point 1002A and inflection point 1002B may be identified as corresponding to an increasing state. The state of MIDI control motion between inflection point 1002B and inflection point 1002C may be identified as corresponding to a stable moving state. The state of MIDI control motion between inflection point 1002C and inflection point 1002D may be identified as corresponding to a decreasing state. The state of MIDI controller motion subsequent to inflection point 1002D may be identified as corresponding to a stable moving. Slope accumulation windows 1004A-D, collectively referred to as “slope accumulation windows 1004”, are intended to represent periods of time (e.g., each 50 ms in duration) during which the controller data may be monitored. A direction and slope prediction may be determined from data corresponding to each of the slope accumulation windows 1004.

By way of example, if the absolute value of S (denoted |S|) is less than a predefined threshold (e.g., 15, 20, referred to a “slope threshold”), the motion may be categorized as indicating a stable moving state. Otherwise, if S is positive, the motion may be categorized as indicating an increasing state; if S is negative, the motion may be categorized as indicating a decreasing state.

In some embodiments, to identify a stable state, two set of criteria may be utilized. First, if no events are received inside of a second window (e.g., a 100 ms window), the motion may be categorized as indicating a stable state. Alternatively, a separate measurement that is independent of the inflection point and accumulation window method may be used. For example, the controller motion may be categorized as indicating a stable state if:

[(|P̅_{Δ}[c]≤T_{Δ}) and [(|P_{Δ}[l]>T_{Δ})

where T_{Δ} is a predefined threshold (e.g., 3, 4, etc.). In some embodiments, T_{Δ} is set to the value of 3.

In a sense, the Δ terms may be considered analogous to the “velocity” of a pitch bend motion, and the ΔΔ terms may be considered analogous to the “acceleration” of the pitch bend motion.

FIG. 10 illustrates an exemplary use case in which the system begins a slide effect (e.g., the slide discussed in connection with FIGS. 5-7) at start time 1006 corresponding to the end of accumulation window 1004A, plays the slide effect for a duration corresponding to 1008, to end the slide at end time 1010, corresponding to the end of accumulation window 1004B. Another slide effect may begin at start time 1012 corresponding to the end of accumulation window 1004C, played for a duration corresponding to 1014, and ended at end time 1016, corresponding to the end of accumulation window 1004D.

### Modifying the Definition of an Instruments Energy Rating

It can be desirable to use a measurement of an instrument's energy that takes into account the general speed of the notes played and how forcefully the notes are played. This type of energy measurement can be used for modulating the virtual instrument's sound based on the context of the surrounding notes, providing a generalization of the character of those notes. A moving average energy rating utilized by the disclosed system may be defined based on a nonlinear weighed combination of velocity, a time difference from a time associated with a previous noteOn (e.g., a MIDI event corresponding to the start of a previous note) to a time associated with a current noteOn (e.g., a MIDI event corresponding to the start of the current note), and time difference from a time associated with a previous noteOff (e.g., a MIDI event corresponding to the end of a previous note) to a current noteOn. With respect to an upright bass virtual instrument, an energy rating, as defined herein, may be used as to influence attack, smoothing, and handling noise.

In some embodiments, the energy rating may be reset if there is silence for at least a threshold period of time (e.g., 5 seconds, 6 seconds, etc.) or when playback is started.

In some embodiments, the following formula may be used to calculate energy rating E:

E=w_{velocity}*V+w_{silence}*S+(1−w_{velocity}−w_{silence})*O_{Δ}

Where V is the normalized velocity, S is a silence term, O_{Δ} is a Note-On-Delta term, w_{velocity} is a weight of the normalized velocity, and w_{silence} is a weight of the silence term.

In some embodiments, the velocity weight (w_{velocity}) may be set to a predefined value (e.g., 0.2).

In some embodiments, the silence term may be calculated based at least in part on the following formula:

$$S = 1 - \frac{{t}_{silence}}{500}$$

where t_{silence} is the time difference in milliseconds between the previous noteOff and noteOn (or in other words, the duration of silence between the previous note and the current note). In some embodiments, t_{silence} may be limited to a maximum value (500 ms, for example).

In some embodiments, w_{silence} may dynamically change depending on whether there is silence between notes. In some embodiments, the silence weight may be set to 0 if there is any note of the virtual instrument that is overlapping the current note. Otherwise, the silence weight may be set to a predefined or configurable value (e.g., 0.75).

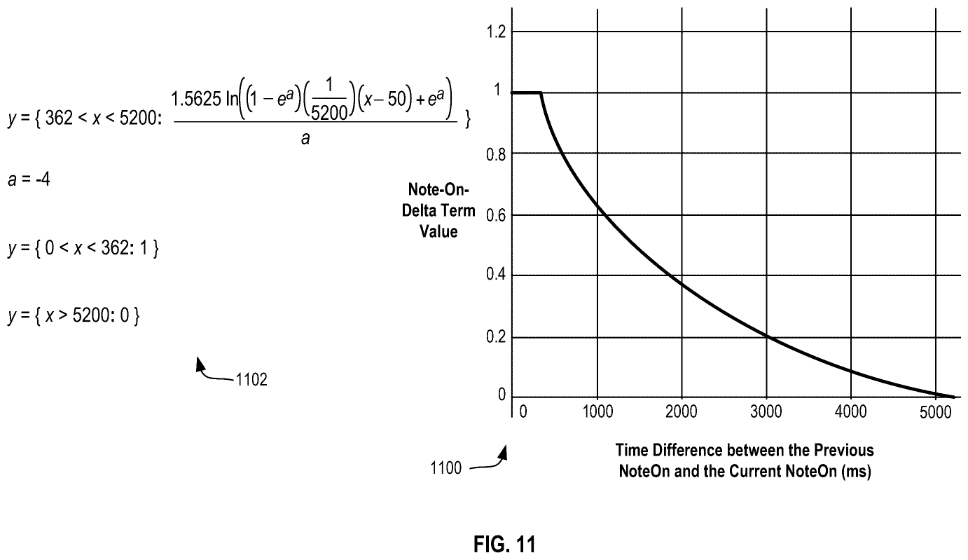

FIG. 11 includes a graph (e.g., graph 1100) corresponding to a piecewise function (e.g., piece-wise function 1102), the graph depicting values of a Note-On-Delta term, in accordance with at least one embodiment. The values depicted in graph 1100 may be used to calculate an energy rating as described above. Graph 1100 may include an x axis that represents the value of the time difference between a time corresponding to the previous noteOn and a time corresponding to the current noteOn. The y axis represents the value of the Note-On-Delta term.

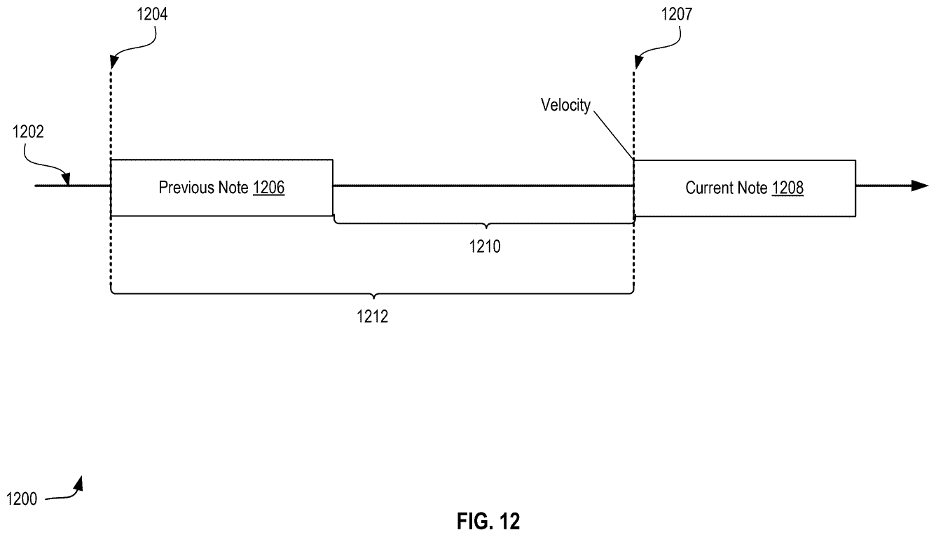

FIG. 12 is an illustration 1200 that visually depicts the parameters for calculating an energy rating, according to at least one embodiment. Timeline 1202 depicts the passage of time. Time 1204 depicts the time associated with a previous noteOn (corresponding to the start time of previous note 1206). Time 1207 depicts the time associated with a current noteOn (corresponding to the start time of current note 1208). Time duration 1210 may represent t_{silence}, the time difference in milliseconds between the previous noteOff (e.g., a MIDI event corresponding to the end of previous note 1206) and noteOn (e.g., 1207), or in other words, the duration of silence between the previous note 1206 and the current note 1208. Time duration is intended to represent a value (x) used as input for the piecewise function (e.g., piece-wise of FIG. 11) corresponding to the Note-On-Delta term represented by graph 1100 of FIG. 11.

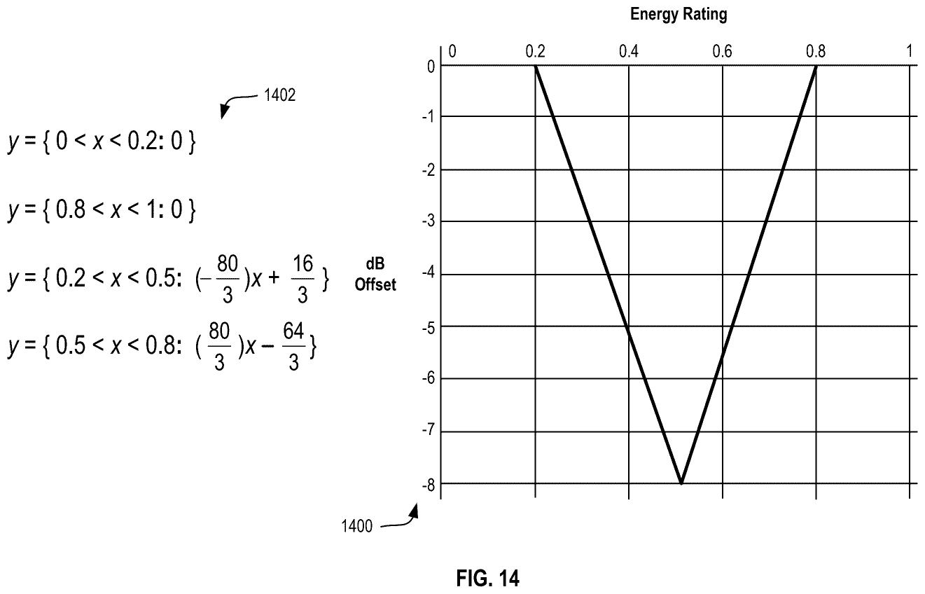

As a non-limiting example, for an upright bass virtual instrument, an energy rating that is calculated using the formulas and methods described above, may be used to influence attack smoothing and handling noise. The handling noise use of energy rating is described in further detail with respect to the method of retroactive editing described herein in connection with FIGS. 14-18. An attack smoothing mechanism may use the calculated energy rating, along with velocity and other factors, to determine a given note's attack. This may make faster runs of notes sound more realistically muddy/congealed compared to slower notes. As a non-limiting example, there may be no attack smoothing for velocities above 100. Between velocity 100 and velocity 80, the attack smoothing may be: E*10 milliseconds, if E<0.35, there may be no attack smoothing. For velocity below 80, attack smoothing may be (E*25)±10 (randomized) milliseconds, if E<0.35, there may be no attack smoothing.

### Simultaneous Monophonic Event Sorting

When two notes are simultaneously received, and they are processed to follow monophonic behavior (that is, one note cuts off the other), the order in which the notes play may be more or less desirable based on the articulations of the notes. There are two categories of articulations: sustained and one-shot. “Sustained articulations” refers to articulations that stay sounding until the user releases the note. “One-shot articulations” refers to articulations that play for a fixed length of time and ignore how long the user note is held. In receiving two simultaneous notes that follow monophonic behavior, a method is disclosed to prioritize scheduling notes with one-shot articulation before notes with sustained articulation. Scheduling notes according to the disclosed prioritization may be more advantageous than conventional scheduling schemes because the fixed-length sounds do not interrupt the sustained sounds. Instead, the fixed-length sound may be triggered first, followed by the sustained sound.

For simultaneous events with different articulations, the order of the MIDI events may be reordered within the same processing block. The reordering uses a priority order of articulations.

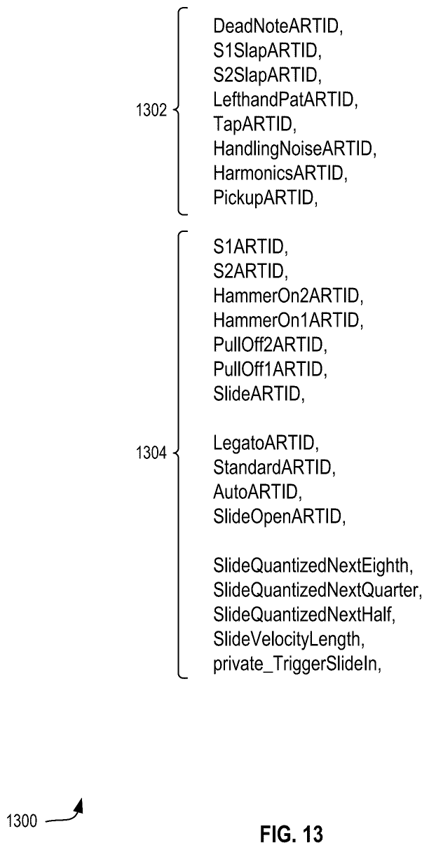

FIG. 13 provides an example list (e.g., list 1300) that depicts an example priority order of articulations, according to at least one embodiment. In some embodiments, the system is configured to play earlier articulations in list 1300 before articulations that occur later in the list. The priority order ensures that sustained articulations do not get cut off. One-shot articulations may be played first due to the fact that the one-shot articulations will not get cut off if played before another one-shot articulation or a sustained articulation. List 1300 may correspond to a list of the menu 212 of FIG. 2.

List 1300 may include a number of one-shot articulations (e.g., one-shot articulations 1302). One-shot articulations 1302 may include, in the order depicted in FIG. 13 (e.g., from highest priority to lowest), “DeadNoteARTID” which may refer to an articulation that includes a short, muted, plucked note, “S1SlapARTID which may refer to an articulation that includes a sound of hand slapping the string, “S2SlapARTID” which may refer to an articulation that includes a short sound of hand slapping the string the second time, “LefthandPatARTID” which may refer to an articulation that includes a short sound of left hand patting the strings, “TapARTID” which may refer to an articulation that includes a short sound of tapping an upright bass's wooden body, “HandlingNoiseARTID which may refer to an articulation that includes a short little creaking sounds of someone moving around the instrument, “HarmonicsARTID” which may refer to an articulation that includes a short sound of plucking the string and muting it along a resonant node of the string, leading to a muted harmonic ring, and “PickupARTID” which may refer to an articulation that includes a short, dull note we designed to mimic stylistic playing that involves a pickup note right before a main note.

List 1300 may include a set of held notes and other longer articulations corresponding to articulations 1304. Articulations 1304 may include “S1ARTID” which may refer to an articulation that includes a main plucked note, “S2ARTID” which may refer to an articulation that includes a main plucked note after another main plucked note, “HammerOn2ARTID” which may refer to an articulation that includes a note created from “hammering on” the finger 2 half steps above a previously ringing note, transferring the strings vibrations into the new note, “HammerOn1ARTID” which may refer to an articulation that includes a note created from “hammering on” the finger 1 half step above a previously ringing note, transferring the strings vibrations into the new note, “PullOff2ARTID” which may refer to an articulation that includes a note created from “pulling off” the finger while another finger is positioned 2 half steps below a previously ringing note, transferring the strings vibrations into the new note, “PullOff1ARTID” which may refer to an articulation that includes a note created from “pulling off” the finger while another finger is positioned 1 half step below a previously ringing note, transferring the strings vibrations into the new note, and “SLIDESARTID” which may refer to an articulation that includes a note created from plucking while sliding the finger up or down the string.

In some embodiments, articulations 1304 may include “LegatoARTID” which may refer to an articulation that includes a playing mode consisting of S1, S2 (for the same pitch), HammerOns and PullOffs, and also includes handling noise and hand position change FX (an effects sample), “StandardARTID” which may refer to an articulation that includes a playing mode consisting of S1 and S2, and also includes handling noise and hand position change FX, “AutoARTID” which may refer to an articulation that includes a default playing mode consisting of S1, S2, auto pickups (in playback only), hammer ons, pull offs, fixed rate portamento slides (e.g., a slide having a lower velocity than hammer ons and pull offs), loud note>125 velocity auto slaps, and dead notes<20 velocity, and “SlideOpenARTID” which may refer to an articulation that includes a scripted articulation that stops a note with a long slide down or up, dependent on whether the pitch is below or above current note, and ends in a release sample. In some embodiments, hotkey velocity may determine speed. If played from silence, an S1 articulation is played and a long slide down (e.g. intro slide).

Articulations 1304 may further include “SlideQuantizedNextEighth” which may refer to an articulation (e.g., a slide) that includes an eighth note, where the slide length is at least a dotted sixteenth note and the end becomes longer to get to the next eighth note. Articulations may further include “SlideQuantizedNextQuarter” which may refer to an articulation (e.g., a slide) that includes a quarter note, where the slide length is at least a dotted eighth note, and then the end becomes longer to get to the next quarter note subdivision. Articulations 1304 may further include “SlideQuantizedNextHalf” which may refer to an articulation (e.g., a slide) that includes a half note, where the slide length is at least a dotted quarter note, and then the end becomes longer to get to the next half note subdivision. Articulations 1304 may further include “Slide VelocityLength” which may refer to a scripted articulation that provides automatic slides (down/up, short/long, fast/med/slow), starting on a start note with which a slide type may be determined. In some embodiments, the slide starts with a noteOn and slide speed may be determined by velocity where speed=0.5 (an eighth) when the velocity is greater than or equal to 40, and 0.125 (a thirty second) when the velocity is less than or equal to 120.

Articulations 1304 may further include “private_TriggerSlideIn” which may be included in the priority list (e.g., list 1300) in order to implement a series of “Slide In” articulations, these articulations may automatically concatenate an S1 with a fast slide up or down.

### Techniques for Retroactive Editing

Virtual instruments provide various articulations, representing different ways to play a note. Typically, users select the articulation for each note, overriding a default one. This is difficult for novice players and tedious for anyone trying to memorialize a musical idea. In idiomatic playing of the upright bass, there are certain combinations of notes in which certain articulations happen. An automatic system is disclosed in which the articulation for a note may be chosen based on the context of the surrounding notes. Additionally, the system can generate new events based on the context of the surrounding notes.

While it's straightforward to implement a system that determines articulations for future events or generates new future events based on current context, it is more challenging to implement a system that determines articulations for past events or generates new events in the past based on current context. The disclosed systems and methods address the more intricate challenge of choosing articulations for past events or generating new events in the past, based on the current context.

In some embodiments, an upright bass virtual instrument runs on a certain latency (e.g., 200 ms of latency), which enables the system to retroactively edit “previous events” (e.g., events occurring within the past 200 ms). From another lens, future events (e.g., events occurring within 200 ms in the future) may be processed before rendering current events. Specifically, there are a number (e.g., three) instances of retroactive editing for an upright bass virtual instrument including pickup notes, inter-note handling noises, and inter-note hand position change sounds. A “pickup note” refers to a short note intended by a player to come right before a more prominent note. It sounds more muted and duller than a standard note. “Inter-note handling noises” refer to creeks that happen from the player handling the instrument. They can happen as additional events in between notes. “Inter-note hand position change” are intended to refer to sounds that happen when a player moves their hand location on an upright bass's fingerboard. These sounds may include a short zipping of the finger on the string when moving the hand. Inter-note hand position changes can also happen as additional events in between notes. For automatic pickup notes, an articulation of a previous event may be modified to be a pickup note when it is within 200 ms of the current note.

For the automatic inter-note handling noises and inter-note hand position change sounds, new events of these articulations may be generated that are within a threshold (e.g., 200 ms, or the like) in the past and between the previous and current event. More specific conditions around each of the use cases for retroactive editing are discussed in more detail below.

In some embodiments, the system may be configured to provide handling noise anytime within standard notes except when the previous pitch is the same as the current pitch. In addition, handling noise may not be played on instrument reset, when there is a long pause (e.g., a pause over a threshold, such as two seconds), or when the energy rating breaches an energy threshold (e.g., when the energy rating discussed herein exceeds 0.7, etc.). In some cases, an undesirable lack of note clarity may be experienced with notes that are too fast (e.g., are associated with an energy rating >0.7) and handling noise may not happen.

In some embodiments, when a player's amount of activity is very low, handling noise may be more prevalent due to handling the instrument carefully. When the player's amount of activity is very high, handling noise may be more prevalent due to the player's inaccuracy. When the player's activity is closer to medium, handling noise may be less prevalent due to the player being technically more consistent. The disclosed techniques provide varying handling noise velocity based on an energy rating according to the graph presented at FIG. 14.

FIG. 14 is a graph (e.g., graph 1400) corresponding to a piecewise function (e.g., piecewise function 1402) for identifying a decibel (dB) offset based on an energy rating, according to at least one embodiment. In some embodiments, a maximum dB offset (e.g., −8.0 dB) may be used (e.g., at energy rating value 0.5) as depicted in graph 1400. As depicted, graph includes an x axis that indicates the value of the energy rating and a y axis that indicates corresponding values of the dB offset. Handling noise velocity may be modified based on identifying the dB offset value via piecewise function 1402 using the energy rating (e.g., the energy rating calculated in the manner described above) and the dB offset value is converted into a velocity offset based on the instrument's dynamic range (e.g., a dynamic range of 0 to −30 dB)). In some embodiments, an offset for the user controlling of handling noise may be applied at the end.

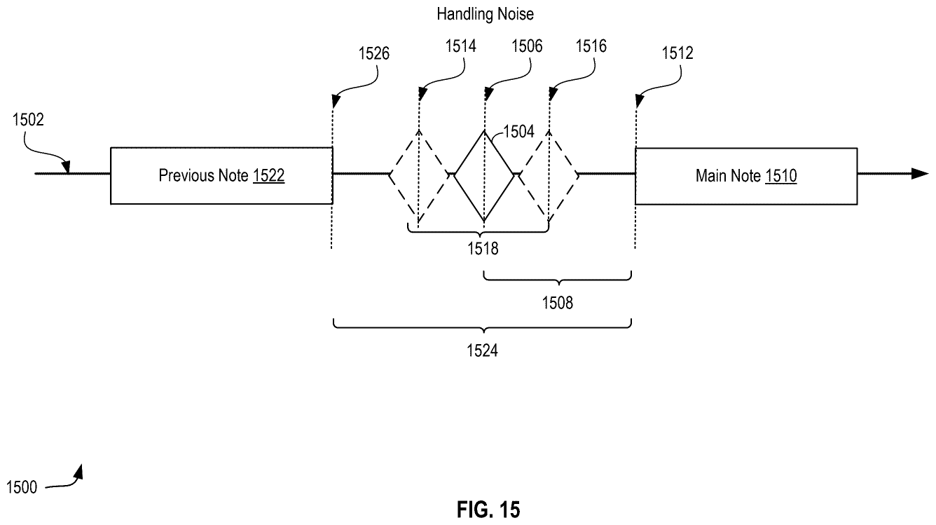

FIG. 15 is an illustration 1500 that visually depicts aspects of handling noise timing, according to at least one embodiment. Timeline 1502 depicts the passage of time. As depicted in FIG. 15, handling noise may be provided by the system before main notes (thus, the “retroactive editing” designation) as depicted by handling noise 1504. Handling noise 1504 may be started at start time 1506 based at least in part on identifying a time corresponding to a predefined period of time (e.g., −130 ms, corresponding to time period 1508) before the start time of main note (e.g., start time 1512)). In some embodiments, the start time for handling noise 1504 (e.g., start time 1506) may be randomly selected as a time including or between times 1514 and 1516, represented by range 1518, where times 1514 and 1516 are identified based on adding and subtracting a threshold time value (e.g., 40 ms) from start time 1506. In some embodiments, the range (e.g., the period of time between start time 1512 and time 1514 may be limited by a predefined range (e.g., between −200 ms (200 ms prior to start time 1512) and 0 ms, representing start time 1512). In some embodiments, the range may also be limited to the space between the previous note 1522 and the main note 1510 (e.g., time period 1524 corresponding to the time between end time 1526 of previous note 1522 and start time 1512 of main note 1510 (a “current note”)).

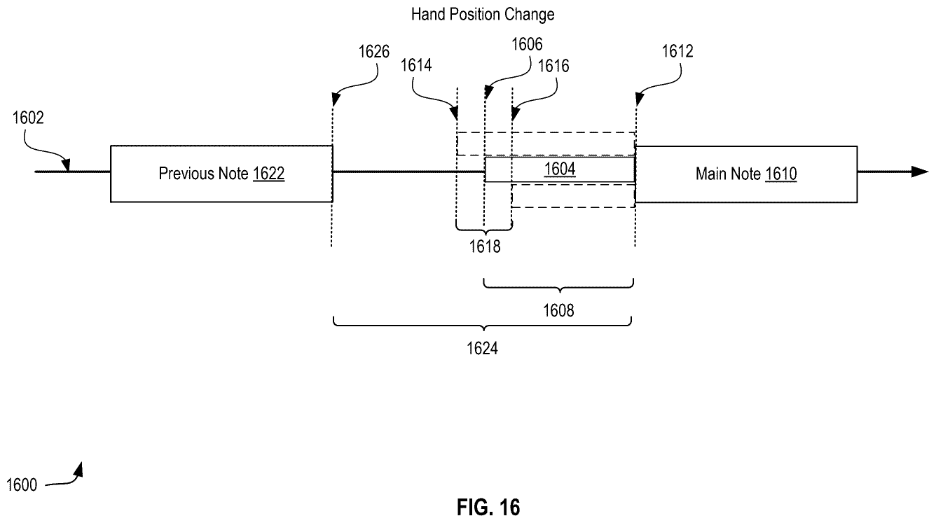

FIG. 16 is an illustration 1600 that visually depicts aspects of hand position change timing, according to at least one embodiment. In some embodiments, the system may be configured to forgo a finger slide directly after an instrument reset. As another example, the system may execute instructions that cause a finger slide when the difference between the last “hand position” and a current hand position is greater or equal to a predefined hand position threshold (e.g., one), where “hand position” is defined as which half step location the hand is currently positioned on.

If the difference between the last and current hand position equals or breaches the predefined hand position threshold, the hand position change timing for playing the hand position change is depicted in FIG. 16. Timeline 1602 depicts the passage of time. As depicted in FIG. 16, a hand position change may be provided by the system before main notes (thus, the “retroactive editing” designation) as depicted by hand position change 1604. Hand position change 1604 may be started at start time 1606 based at least in part on identifying a time corresponding to a predefined period of time (e.g., −160 ms, corresponding to time period 1608) before the start time of main note 1610 (e.g., start time 1612)). In some embodiments, the start time for hand position change 1604 (e.g., start time 1606) may be randomly selected as a time including or between times 1614 and 1616, represented by range 1618, where times 1614 and are identified based on adding and subtracting a threshold time value (e.g., 40 ms) from start time 1606. In some embodiments, the range (e.g., the period of time between start time and start time 1614 may be limited by a predefined range (e.g., between −200 ms (200 ms prior to start time 1612) and 0 ms, representing start time 1612). In some embodiments, the range may also be limited to the space between the previous note 1622 and the main note 1610 (e.g., time period 1624 corresponding to the time between end time 1626 of previous note 1622 and start time 1612 of main note 1610 (a “current note”)).

In some embodiments, “fast slide” samples that are specific to a particular string may be used for hand position changes. By way of example, there may be 22 samples corresponding to the E string (referred to as an “E string sample set”), 35 for the A string referred to as an “A string sample set”), 39 for the D string (referred to as an “D string sample set”), and 35 for the G string referred to as an “G string sample set”), although any suitable number of samples may be employed for each string. In some embodiments, the last activated string may be used to select which bank/group of hand position changes from which a sample is to be selected. Sample selection may be randomized (meaning a random sample may be selected from the selected set, for example, the E string sample set).

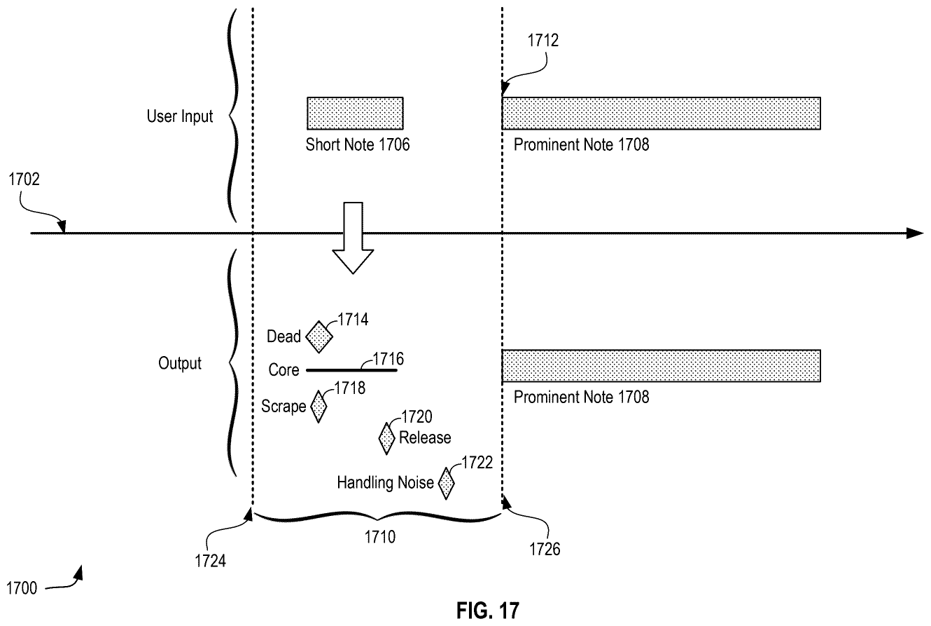

FIG. 17 is an illustration 1700 that visually depicts aspects of combining sound layers to create a pickup note, according to at least one embodiment. Timeline 1702 is intended to depict the passage of time. In some embodiments, automatic pickup notes may be presented when a short note (e.g., short note 1706) is followed by a more prominent note (e.g., prominent note 1708. In some embodiments, the articulation (e.g., sound layers) of the short note 1706 may be changed into a pickup note. In some embodiments, the short note 1706 must be within a threshold range (e.g., within range 1710, corresponding to 200 ms before the start time 1712 of prominent note 1708). Time 1724 is intended to represent an actual processing time (e.g., a time in the past) and time 1726 is intended to represent the current time. In some embodiments, creating a pickup note according to the disclosed techniques occurs during playback, but not in real-time playing. In some embodiments, the automatic pickup note may be used only when the instrument is in an auto mode. The system may further limit the use of pickup notes to situations where the energy rating (e.g., an energy rating discussed above) is less than or equal to a predefined energy rating threshold (e.g., 0.7).

As depicted in FIG. 17, five sound layers may be combined to create a pickup note with which short note 1706 is replaced: a dead-note (e.g., dead-note 1714 corresponding to a more muted sounding note), a core (e.g., core 1716 corresponding to a regular instrument pluck), a scrape (e.g., scrape 1718, corresponding to a starting transient of a pickup note), a release (e.g., release 1720 corresponding to the sound at the end of the pickup note), and handling noise (e.g., handling noise 1722 corresponding to a creaking sound between the release 1720 of the pickup note and the start (e.g., start time 1712) of prominent note 1708.

In some embodiments, various attributes for any suitable combination of the sound layers corresponding to dead-note 1714, core 1716, scrape 1718, release 1720, and handling noise 1722 may be adjusted. By way of example, the velocity of the layer corresponding to dead-note 1714 may be kept at the same velocity as the velocity of short note 1706. In some embodiments, the layers corresponding to core 1716, and scrape 1718 may be some decibel value (e.g., −10 dB) down from dead-note 1714. In some embodiments, this may be implemented through velocity, using a conversion between dB and velocity based an instrument dynamic range (e.g., −30 dB) as mentioned above. In some embodiments, the velocity of release 1720 may be configured to follow a pattern used across the instrument, where a decay curve is used starting with the core velocity and decays with respect to time. In some embodiments, the new short pickup note corresponding to dead-note 1714, core 1716, scrape 1718, and release 1720 may be limited in duration based at least in part on a predefined maximum threshold (e.g., up to 150 ms, maximum).

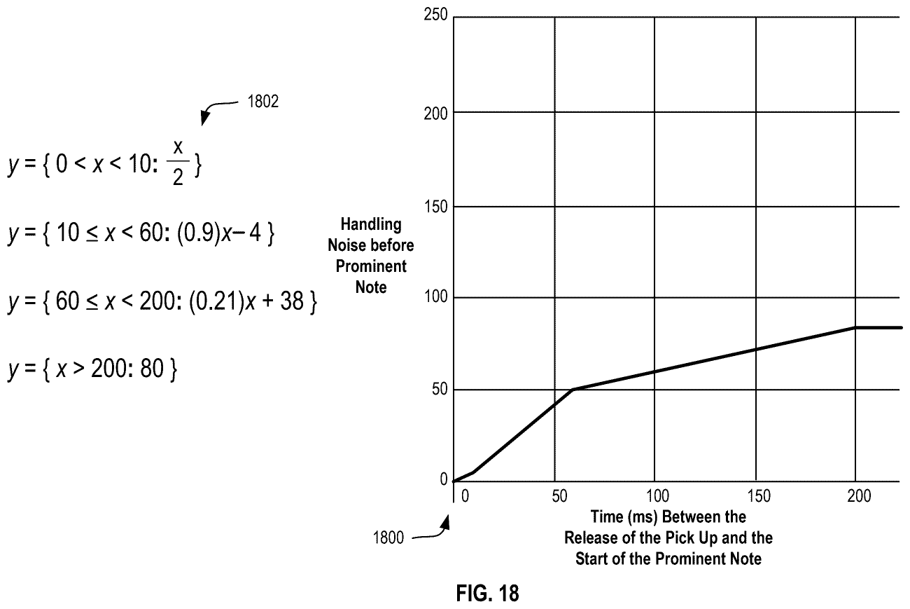

FIG. 18 is a graph 1800 and corresponding piecewise function 1802 for identifying the timing of handling noise (e.g., handling noise 1722 of FIG. 17) provided before a main note (e.g., prominent note 1708 of FIG. 17), according to at least one embodiment. Graph 1800 may include an x axis which indicates the time between the release of the new pickup note (e.g., a time corresponding to release 1720 of FIG. 17) and the start time of the prominent note (e.g., start time 1712 of prominent note 1708 of FIG. 17). As depicted, graph 1800 includes a y axis that indicates a time corresponding to the handing noise (e.g., a start time for handling noise 1722).

### Example Musical Performance System

FIG. 19 illustrates an example of a musical performance system (e.g., DAW 104 of FIG. 1) that can enable a user to compose and create music with a number of virtual instruments on a music application, according to an embodiment of the disclosure. Musical performance system 1900 can include multiple subsystems such as a display 1905, one or more processing unit(s) 1910, and a storage subsystem 1915. One or more communication paths can be provided to enable one or more of the subsystems to communicate with and exchange data with one another. The various subsystems in FIG. 19 can be implemented in software, in hardware, or combinations thereof. In some embodiments, the software can be stored on a transitory or non-transitory computer readable storage medium and can be executed by one or more processing units.

It should be appreciated that musical performance system 1900 as shown in FIG. 19 can include more or fewer components than those shown in FIG. 19, can combine two or more components, or can have a different configuration or arrangement of components. In some embodiments, musical performance system 1900 can be a part of a portable computing device, such as a tablet computer, a mobile telephone, a smart phone, a desktop computer, a laptop computer, a kiosk, etc.

Display 1905 in some embodiments can provide an interface that allows a user to interact with musical performance system 1900. Display 1905 can be a monitor or a screen in some embodiments. Through the interface, the user can view and interact with a GUI 1920 (e.g., UI 200 of FIG. 2) of a musical performance system 1900. In some embodiments, display 1905 can include a touch-sensitive interface (also sometimes referred to as a touch screen) that can both display information to the user and receive inputs from the user. Processing unit(s) 1910 can include one or more processors that each have one or more cores. In some embodiments, processing unites) 1910 can execute instructions stored in storage subsystem 1915. System 1900 may also include other types of user input and output mechanisms such as allowing a user to provide an input based at least in part on received accelerometer or gyroscope sensor readings (internal to musical performance system 1900) or provide output such as haptic output based at least in part on a desired musical characteristic.

Storage subsystem 1915 can include various memory units such as a system memory 1930, a read-only memory (ROM) 1940, and a permanent storage device 1950. The system memory can be a read-and-write memory device or a volatile read-and-write memory, such as dynamic random access memory. The system memory can store some or all of the instructions and data that the processor needs at runtime. The ROM can store static data and instructions that are needed by processing unites) 1910 and other modules of system 1900. The permanent storage device can be a read-and-write memory device. Some embodiments of the disclosure can use a mass-storage device (such as a magnetic or optical disk or flash memory) as a permanent storage device. Other embodiments can use a removable storage device (e.g., a floppy disk, a flash drive) as a permanent storage device.

Storage subsystem 1915 can store a touch gesture library that includes a number of system recognizable touch gestures 1932 on the GUI 1920, MIDI-controlled audio samples 1934 for storing data relating to music played on the virtual instruments, and virtual instrument data for storing information about each virtual instrument. Further detail regarding system architecture and auxiliary components thereof are not discussed in detail so as not to obfuscate the focus on the disclosure and would be understood by those of ordinary skill in the art.

What is claimed is:

1. A computer-implemented method for selecting a playing mode for playing a note that is associated with a virtual instrument corresponding to a physical instrument, comprising:
obtaining, by a computing device, first Musical Instrument Digital Interface (MIDI) data corresponding to a first note that is associated with the virtual instrument and second MIDI data corresponding to a second note that is associated with the virtual instrument;
identifying, by the computing device and based at least in part on the first MIDI data and the second MIDI data, a velocity of the second note, a pitch interval between the first note and the second note, and a difference between a first time corresponding to the first note and a second time corresponding to the second note;
selecting, by the computing device and based at least in part on the velocity, the pitch interval, and the difference between the first time and the second time, the playing mode for playing the second note, the playing mode being selected from 1) a first playing mode that, when utilized, causes the second note to sound while the first note is sounding or 2) a second playing mode that, when utilized, causes the first note to be interrupted with the second note; and
executing, by the computing device, operations that cause the second note to be played according to the playing mode.

2. The computer-implemented method of claim 1, further comprising determining, by the computing device, a duration that the first note has been played, wherein the playing mode for playing the second note is selected further based at least in part on the duration that the first note has been played.

3. The computer-implemented method of claim 2, wherein the second playing mode for playing the second note is selected based at least in part on:
determining, from the second MIDI data, that the velocity of the second note falls below a predefined velocity threshold value;
determining, based at least in part on the first MIDI data and the second MIDI data, that the pitch interval between the first note and the second note falls below a predefined interval threshold;
determining, based at least in part on the first MIDI data and the second MIDI data, that the difference between the first time corresponding to the first note and the second time corresponding to the second note exceeds a predefined timing threshold; and
determining, that the difference between the first time and the second time is less than a portion of the duration of the first note.

4. The computer-implemented method of claim 3, wherein the predefined velocity threshold value is seventy, and wherein the predefined interval threshold corresponds to seven half steps.

5. The computer-implemented method of claim 1, wherein the second playing mode for playing the second note is selected based at least in part on:
determining, from the second MIDI data, that the velocity of the second note meets or exceeds a predefined velocity threshold value;
determining, based at least in part on the first MIDI data and the second MIDI data, that the pitch interval between the first note and the second note exceeds a predefined interval threshold; and
determining, based at least in part on the first MIDI data and the second MIDI data, that the difference between the first time corresponding to the first note and the second time corresponding to the second note exceeds a predefined timing threshold.

6. The computer-implemented method of claim 5, wherein the predefined interval threshold corresponds to two half steps.

7. The computer-implemented method of claim 1, wherein the first playing mode is a default playing mode, and wherein selecting the second playing mode causes the default playing mode to be overridden.

8. A computing device, comprising:
one or more processors; and
one or more memories storing computer-executable instructions that, when executed by the one or more processors, cause the one or more processors to:
obtain first Musical Instrument Digital Interface (MIDI) data corresponding to a first note that is associated with a virtual instrument and second MIDI data corresponding to a second note that is associated with the virtual instrument;
identify, based at least in part on the first MIDI data and the second MIDI data, a velocity of the second note, a pitch interval between the first note and the second note, and a difference between a first time corresponding to the first note and a second time corresponding to the second note;
select, based at least in part on the velocity, the pitch interval, and the difference between the first time and the second time, a playing mode for playing the second note, the playing mode being selected from 1) a first playing mode that, when utilized, causes the second note to sound while the first note is sounding or 2) a second playing mode that, when utilized, causes the first note to be interrupted with the second note; and
execute operations that cause the second note to be played according to the playing mode.

9. The computing device of claim 8, wherein executing the computer-executable instructions further causes the one or more processors to determine a duration that the first note has been played, wherein the playing mode for playing the second note is selected further based at least in part on the duration that the first note has been played.

10. The computing device claim 9, wherein the second playing mode for playing the second note is selected based at least in part on:
determining, from the second MIDI data, that the velocity of the second note falls below a predefined velocity threshold value;
determining, based at least in part on the first MIDI data and the second MIDI data, that the pitch interval between the first note and the second note falls below a predefined interval threshold;
determining, based at least in part on the first MIDI data and the second MIDI data, that the difference between the first time corresponding to the first note and the second time corresponding to the second note exceeds a predefined timing threshold; and
determining, that the difference between the first time and the second time is less than a portion of the duration of the first note.

11. The computing device of claim 10, wherein the predefined velocity threshold value is seventy, and wherein the predefined interval threshold corresponds to seven half steps.

12. The computing device of claim 8, wherein the second playing mode for playing the second note is selected based at least in part on:
determining, from the second MIDI data, that the velocity of the second note meets or exceeds a predefined velocity threshold value;
determining, based at least in part on the first MIDI data and the second MIDI data, that the pitch interval between the first note and the second note exceeds a predefined interval threshold; and
determining, based at least in part on the first MIDI data and the second MIDI data, that the difference between the first time corresponding to the first note and the second time corresponding to the second note exceeds a predefined timing threshold.

13. The computing device of claim 12, wherein the predefined interval threshold corresponds to two half steps.

14. The computing device of claim 8, wherein the first playing mode is a default playing mode, and wherein selecting the second playing mode causes the default playing mode to be overridden.

15. A non-transitory computer-readable medium storing computer-executable instructions that, when executed by one or more processors of a computing device, cause the one or more processors to:
obtain first Musical Instrument Digital Interface (MIDI) data corresponding to a first note that is associated with a virtual instrument and second MIDI data corresponding to a second note that is associated with the virtual instrument;
identify, based at least in part on the first MIDI data and the second MIDI data, a velocity of the second note, a pitch interval between the first note and the second note, and a difference between a first time corresponding to the first note and a second time corresponding to the second note;
select, based at least in part on the velocity, the pitch interval, and the difference between the first time and the second time, a playing mode for playing the second note, the playing mode being selected from 1) a first playing mode that, when utilized, causes the second note to sound while the first note is sounding or 2) a second playing mode that, when utilized, causes the first note to be interrupted with the second note; and
execute operations that cause the second note to be played according to the playing mode.

16. The non-transitory computer-readable medium of claim 15, wherein executing the computer-executable instructions further causes the one or more processors to determine a duration that the first note has been played, wherein the playing mode for playing the second note is selected further based at least in part on the duration that the first note has been played.

17. The non-transitory computer-readable medium claim 16, wherein the second playing mode for playing the second note is selected based at least in part on:
determining, from the second MIDI data, that the velocity of the second note falls below a predefined velocity threshold value;
determining, based at least in part on the first MIDI data and the second MIDI data, that the pitch interval between the first note and the second note falls below a predefined interval threshold;
determining, based at least in part on the first MIDI data and the second MIDI data, that the difference between the first time corresponding to the first note and the second time corresponding to the second note exceeds a predefined timing threshold; and
determining, that the difference between the first time and the second time is less than a portion of the duration of the first note.

18. The non-transitory computer-readable medium of claim 17, wherein the predefined velocity threshold value is seventy, and wherein the predefined interval threshold corresponds to seven half steps.

19. The non-transitory computer-readable medium of claim 15, wherein the second playing mode for playing the second note is selected based at least in part on:
determining, from the second MIDI data, that the velocity of the second note meets or exceeds a predefined velocity threshold value;
determining, based at least in part on the first MIDI data and the second MIDI data, that the pitch interval between the first note and the second note exceeds a predefined interval threshold; and
determining, based at least in part on the first MIDI data and the second MIDI data, that the difference between the first time corresponding to the first note and the second time corresponding to the second note exceeds a predefined timing threshold.

20. The non-transitory computer-readable medium of claim 19, wherein the predefined interval threshold corresponds to two half steps.
